(19) United States
(12) Patent Application Publication
(10) Pub. No.: US 2025/0280036 A1
(43) Pub. Date: Sep. 4, 2025

(54) AUTOMATIC DETECTION AND PREVENTION OF PHISHING PLATFORMS

(71) Applicant: Intuit Inc., Mountain View, CA (US)

(72) Inventors: Abhishek TATTI, San Jose, CA (US); Jason Dee Troy MARLEY, San Diego, CA (US); Scott Cruickshanks KENNEDY, San Diego, CA (US); Vincent LU, Milpitas, CA (US); Caroline SHOURABOURA, Seattle, WA (US)

(73) Assignee: Intuit Inc., Mountain View, CA (US)

(21) Appl. No.: 18/591,329

(22) Filed: Feb. 29, 2024

(51) Int. Cl. H04L 9/40

(52) U.S. Cl. CPC H04L 63/1483

(57) ABSTRACT

Systems and methods are disclosed for the automatic detection and prevention of phishing platforms. Detection of an internet domain being a phishing platform is based on screenshots of the domain's website as compared to website screenshots of previously identified internet domains of phishing platforms, seed domains, and other identified domains (such as a typosquatting domain or an error domain). To compare screenshots, the system generates a perceptual hash for each screenshot to be compared, and the system generates a similarity metric for each pairing of the internet domain's screenshot and each screenshot of the other domains to be compared. The internet domain may be classified as the same as the domain in the pair associated with the highest similarity metric across all of the similarity metrics. The internet domain may be identified as a phishing platform if the associated domain in the pair was previously identified as a phishing platform.

### TECHNICAL FIELD

This disclosure relates generally to the automatic detection of domains that conflict with a source domain, including the identification of phishing platforms or other conflicting domains corresponding to the source domain based on screenshots from the conflicting domain, the source domain, and other domains previously identified as being a conflicting domain.

### DESCRIPTION OF RELATED ART

An entity may own and utilize one or more domains, such as by including a website to provide a service or information to domain visitors. Each domain has a domain name, which is a part of the universal resource locator (URL) that is a user-friendly form of the internet protocol (IP) address. A visitor may type a domain name (or a full URL) into the URL bar of a web browser to access a website hosted on the domain for the entity. A user may incorrectly type the domain name or URL, such as inadvertently including one or more additional characters, not including one or more characters, or including a spelling mistake. If the incorrect domain name is from a domain that is not owned or utilized, the web browser may display an error (such as a hypertext transfer protocol (HTTP) 404 error). However, some businesses or individuals may purchase and utilize domains intentionally to have similar domain names to the entity's domain name but for minor differences in the domain name. Such conflicting domains with similar domain names may be used for cybersquatting (which may be referred to as a typosquatting domain) in the hopes that the entity owning the properly spelled domain (which may be referred to as a source domain or seed domain) will purchase the erroneous domain name. Such typosquatting may also be used to divert user traffic towards advertisement revenue generating actions (such as a website having sponsored links or pop-ups). Even more egregious than a typosquatting domain, a user may purchase a conflicting domain name to set up a phishing platform. A phishing platform includes a domain having a website that mimics a website of the source domain to attempt to trick visitors of the phishing platform to divulge personal information (such as usernames and passwords). Such a domain may be referred to as an impersonating domain.

### SUMMARY

Systems and methods are disclosed for the automatic detection and prevention of phishing platforms. Detection of an internet domain being a phishing platform is based on screenshots of the domain's website as compared to website screenshots of previously identified internet domains of phishing platforms, seed domains, and other identified conflicting domains (such as a typosquatting domain or an error domain). To compare screenshots, the system generates a perceptual hash for each screenshot to be compared, and the system generates a similarity metric (referred to herein as a similarity) for each pairing of the internet domain's screenshot and each screenshot of the other domains to be compared. The internet domain may be classified to be the same as the domain in the pair associated with the highest similarity metric across all of the similarity metrics. For example, the internet domain may be identified as a phishing platform if the associated domain in the pair was previously identified as a phishing platform. The system to identify phishing platforms analyzes thousands, tens of thousands, or more domains daily to keep track of domains previously classified as a typosquatting domain or being owned but not being utilized (such as no website being hosted for incoming traffic) such that an error is generated when attempting to reach the domain (referred to herein as an error domain). The system also generates a notification to indicate any identified domains associated with a phishing platform (an impersonating domain), and such notifications may be provided to users of the seed domain and may also be used to initiate the removal of such domains as fraudulent. Such means to identify a phishing platform may also be used to identify other types of conflicting domains, and the identified conflicting domains may be stored and used in the future analysis of internet domains to attempt to identify additional conflicting domains.

One innovative aspect of the subject matter described in this disclosure can be implemented as a computer-implemented method for classifying an internet domain and notifying of a conflicting internet domain. The method includes identifying an internet domain to be analyzed for conflicting with a seed domain. The method also includes receiving, via a digital communication medium, a first screenshot of an internet website of the internet domain. The method further includes generating a first perceptual hash from the first screenshot. The method also includes receiving a second screenshot of a seed website of the seed domain. The method further includes generating a second perceptual hash from the second screenshot. The method also includes calculating a first similarity between the first perceptual hash and the second perceptual hash. The method further includes classifying the internet domain as a conflicting internet domain based on the calculated first similarity. The method also includes generating a notification based on the internet domain being classified as the conflicting internet domain. The method further includes transmitting the notification via the digital communication medium.

Another innovative aspect of the subject matter described in this disclosure can be implemented in a system for classifying an internet domain and notifying of a conflicting internet domain. An example system includes one or more processors and a memory storing instructions that, when executed by the one or more processors, cause the system to perform operations. The operations include identifying an internet domain to be analyzed for conflicting with a seed domain. The operations also include receiving, via a digital communication medium, a first screenshot of an internet website of the internet domain. The operations further include generating a first perceptual hash from the first screenshot. The operations also include receiving a second screenshot of a seed website of the seed domain. The operations further include generating a second perceptual hash from the second screenshot. The operations also include calculating a first similarity between the first perceptual hash and the second perceptual hash. The operations further include classifying the internet domain as a conflicting internet domain based on the calculated first similarity. The operations also include generating a notification based on the internet domain being classified as the conflicting internet domain. The operations further include transmitting the notification via the digital communication medium.

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a screenshot of the Intuit® website login page.

FIG. 2 shows a screenshot of the Mailchimp® website login page.

FIG. 3 shows a screenshot of a typosquatting domain website.

FIG. 4 shows a screenshot of an example hypertext transfer protocol (HTTP) 404 error in the Google® Chrome web browser for an error domain.

FIG. 5 shows an example system for classifying internet domains and notifying of a conflicting internet domain, according to some implementations.

FIG. 6 shows an example network environment for obtaining screenshots from conflicting domains, according to some implementations.

FIG. 7 shows an example block diagram for classifying a domain, according to some implementations.

FIG. 8 shows an illustrative flow chart of an example operation of classifying an internet domain and notifying of a conflicting internet domain, according to some implementations.

FIG. 9 shows an illustrative flow chart of an example operation of classifying an internet domain, according to some implementations.

FIG. 10 shows an illustrative flow chart of an example operation of classifying an internet domain, according to some implementations.

FIG. 11 shows an illustrative flow chart of an example operation of classifying an internet domain, according to some implementations.

FIG. 12 shows an illustrative flow chart of an example operation of classifying an internet domain, according to some implementations.

Like numbers reference like elements throughout the drawings and specification.

### DETAILED DESCRIPTION

Implementations of the subject matter described in this disclosure may be used for the classification of internet domains, including the classification and notification of conflicting domains for a seed domain. In particular, described in this disclosure is a system to monitor, identify, and notify of phishing platforms that pose a security risk to a seed domain.

As used herein, a seed domain (which may also be referred to as a source domain) is the original domain that is to be protected from phishing platforms and other fraudulent domains. For example, Intuit® owns a seed domain having the domain name “Intuit.com” and a seed domain having the domain name “Mailchimp.com.” As used herein, a conflicting domain refers to a domain having a domain name that may be easily confused with a seed domain. For example, a domain may include the domain name “Intuitr.com,” which may be confused with the domain name “Intuit.com” from the seed domain. In another example, a domain may include the domain name “Mailshimp.com,” which may be confused with the domain name “Mailchimp.com.”

For websites, an entity will attempt to register domain names that people would logically associate with the entity, such as a business name, a product name, a service name, and so on. As such, a user may type a domain name (such as “intuit.com”) into the uniform resource locator (URL) bar of a web browser to attempt to access a desired website (such as Intuit's website). However, people frequently mistype the domain name, such as by missing a character, inverting characters, misspelling names, adding a character, or using a different extension (such as “.net” instead of “.com”). For example, a person wishing to access Intuit's website may accidentally type in the domain name “intyuit.com” instead of “intuit.com.”

Larger businesses that register seed domains may also purchase domain names with common misspellings, with those domain names still directing a person to the seed domain. However, smaller businesses or other entities (as well as larger businesses) may not own all common misspelled domain names, much less all of the possible misspelled domain names. In addition, other businesses or individuals may purchase/register unclaimed domain names with misspellings based on the seed domain. Such businesses or individuals may cybersquat (also referred to as domain squatting) on the registered domain name in the hopes that the owner of the seed domain will wish to purchase the domain name and/or in order to direct users unwittingly landing on a web page hosted at that domain to paid advertisements or other paid engagements in order to profit from the users' confusion as to not reaching the seed domain's website. Such domains with an active website are referred to herein as typosquatting domains. Unutilized domains or domains having domain names leading to a browser error (i.e., an HTTP 404 error) are referred to herein as error domains. For example, a person may purchase a domain, but may not set up the domain to have a website for incoming traffic. As such, a user typing in the domain name of the error domain may receive a browser error. Alternatively, the domain name of an error domain may not be registered as thus is not used.

Even more egregious than registering a typosquatting domain or an error domain, some may register a misspelled domain name with the intent of setting up a phishing platform that impersonates the seed domain's website. For example, a phishing platform may include a website that looks similar to the seed domain's website's login page to trick unsuspecting users into entering their login credentials or other personal information. Domains set up to impersonate the seed domain are referred to herein as impersonating domains. Typosquatting domains, error domains, and impersonating domains associated with a seed domain are referred to collectively herein as conflicting domains for that seed domain.

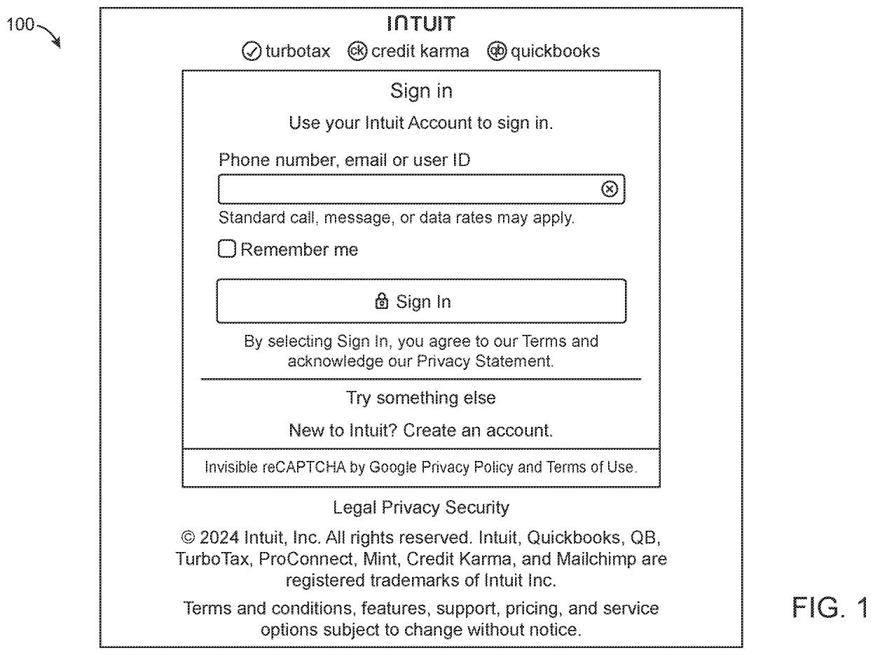

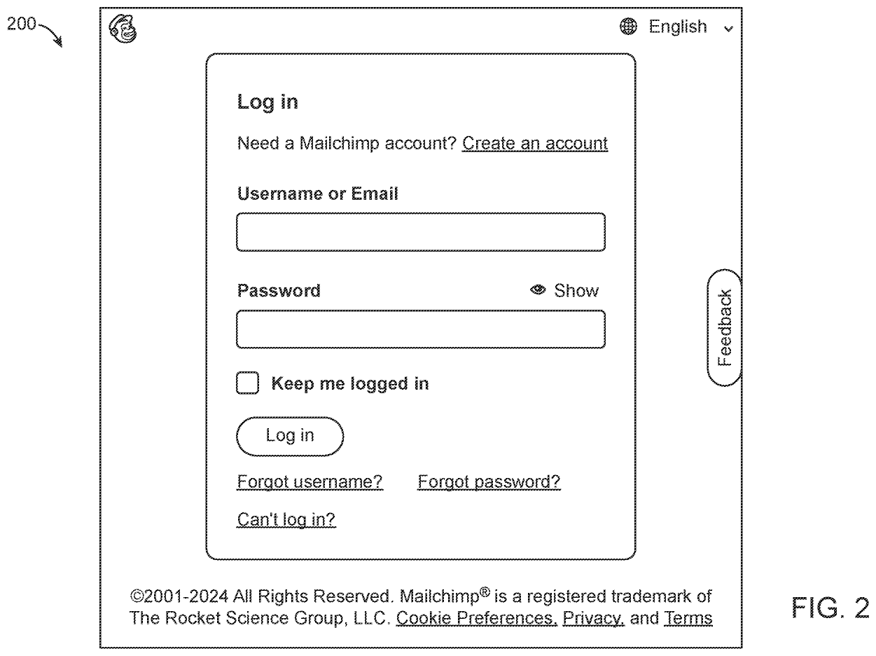

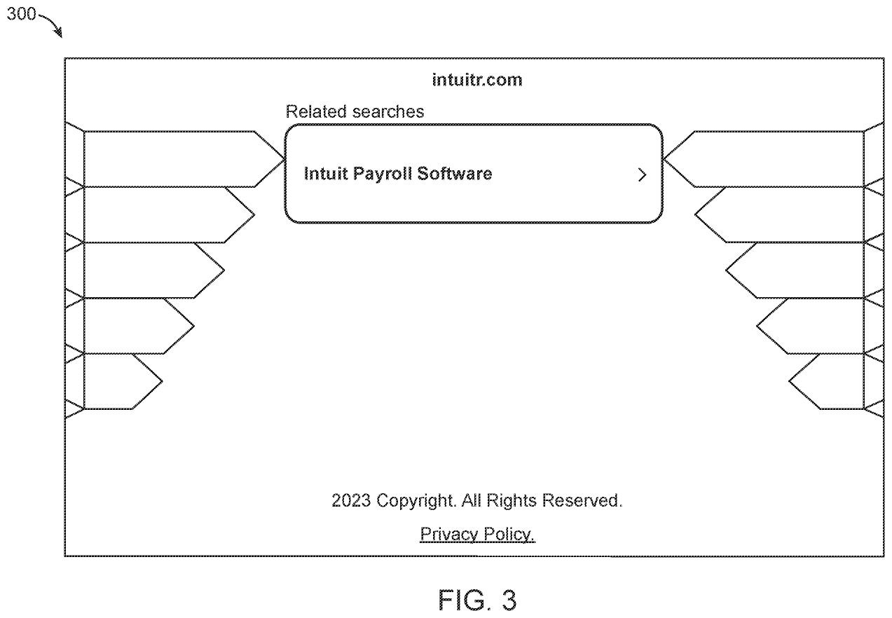

To illustrate examples of conflicting domains, FIG. 1 shows a screenshot 100 of the Intuit website login page. An Intuit user would expect to land on the webpage shown in screenshot 100 if correctly typing “intuit.com” into the URL bar of a web browser. FIG. 2 shows a screenshot 200 of the Mailchimp website login page, with Mailchimp being owned by Intuit. A Mailchimp user would expect to land on the webpage shown in screenshot 200 if correctly typing “login.mailchimp.com” into the URL bar of a web browser. Screenshots 100 and 200 are for seed domains owned and utilized by Intuit. FIG. 3 shows a screenshot 300 of a typosquatting domain website. The typosquatting domain has the domain name “intuitr.com,” which may be confused with the seed domain name “intuit.com.” As such, if an Intuit user erroneously types “intuitr.com” into the URL bar of the web browser, the user would land on the webpage depicted in screenshot 300. To note, screenshot 300 and screenshot 100 are different such that the webpage depicted in screenshot 300 is not attempting to impersonate the seed domain website depicted in screenshot 100. As such, screenshot 300 is for a typosquatting domain. While not as egregious as attempting to trick a user into directly inputting personal information (such as user login information), links on a typosquatting domain website may redirect a user to an unwanted page or cause an unwanted installation on the user's device. In contrast to a typosquatting domain, if a conflicting domain appears similar to screenshot 100 such that a user may confuse the conflicting domain with the seed domain, the conflicting domain is an impersonating domain. The websites between the seed domain and the conflicting domain may appear the same or may have minor differences, such as slightly different copyright notices or in small text within a webpage, a change in shading or contrast, a change in text or object alignment, or other small differences that make the websites not exactly the same but would still confuse a user. Alternatively, an impersonating domain website may not look the same as the seed domain website, but may pretend to be an official website by including specific trademarks, tradenames, logos, or other features that a visitor would normally associate with the seed domain website.

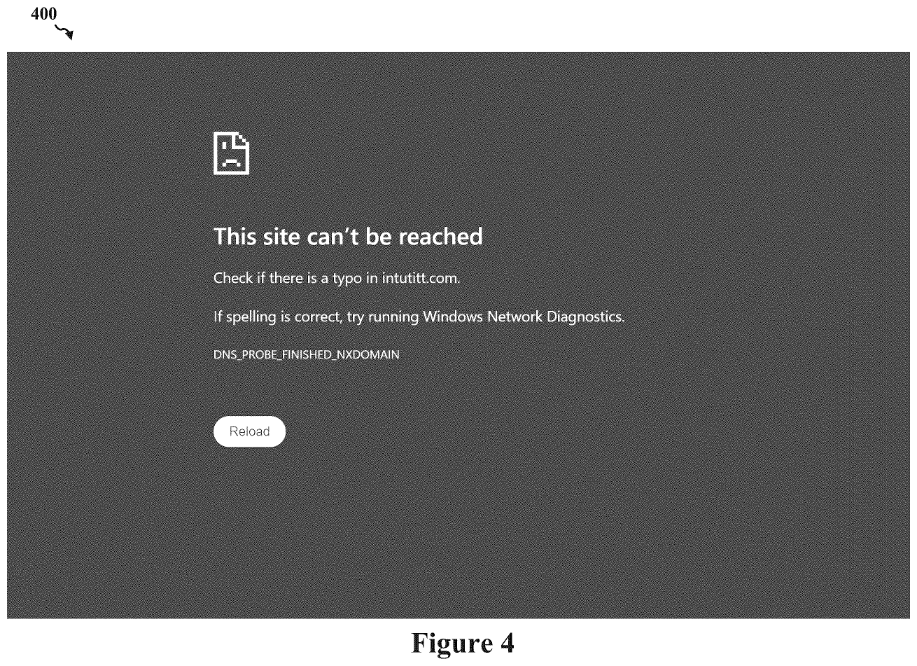

In addition to typosquatting domains and impersonating domains, conflicting domains may also include error domains. An error domain is a domain associated with a misspelling of the seed domain name (such as an incorrect extension, additional character, etc.) but there is no website or other utilization of the domain on which a visitor may land. For example, the domain name may be registered by someone but not utilized. In some implementations, an error domain may also include domains whose names have not been purchased or registered. FIG. 4 shows a screenshot 400 of an example HTTP 404 error (also referred to as a 404 error) in the Google Chrome web browser of an error domain. The domain name attempted that leads to the 404 error is “intutitt.com,” which is not registered and thus not utilized. As such, the screenshot 400 may be associated with an error domain.

To protect seed domain users from typosquatting domains and, more importantly, impersonating domains (as well as to keep track of error domains), the entity owning the seed domain may wish to periodically search for and analyze such conflicting domains. In particular for impersonating domains in which fraud is being committed, the entity may wish to identify the impersonating domain in order to warn users of such domain as well as to have the impersonating domain taken down so that users can no longer visit the impersonating domain and potentially be tricked into providing personal information. The entity may also wish to keep track of typosquatting domains or registered error domains in case the domains transform into an impersonating domain in the future.

Typically, conflicting domain websites need to be manually reviewed by someone tasked to identify conflicting domains for the seed domain. As such, the person manually types into a web browser different domain names of potential conflicting domains, and the person visually inspects the website that is displayed in the web browser in an attempt to identify impersonating and typosquatting domains. A problem with the manual review of websites is that thousands, tens of thousands, or more conflicting domains may exist for a seed domain. Manually reviewing thousands of websites (much less tens of thousands of websites) is impossible in a reasonable amount of time. For example, manually reviewing a thousand websites may take a person a minimum of a week, with the person reviewing over a hundred websites a day. In addition, time is of the essence in identifying impersonating domains, which may appear at any time. As such, review of a large number of domain websites may be required daily, which would be impossible via manual review. Another problem is that manual review requires subjective analysis by the reviewer, which is thus dependent on the knowledge of the reviewer and may vary in quality between reviewers.

As such, there is a need for a system that is able to quantitatively review a large number of domains and identify conflicting domains (especially impersonating domains) in a reasonable amount of time such that the review may be performed quickly and frequently, such as daily.

As described herein, a system is configured to classify an internet domain and notify of a conflicting internet domain, which is performed for thousands or more internet domains daily. In particular, the system identifies impersonating domains based on previously classified conflicting domains and/or a seed domain. To identify a candidate domain as a conflicting domain, one or more screenshots of a website of the candidate domain are captured, and one or more screenshots of a website of the seed domain are captured. The system thus generates a perceptual hash from each of the one or more candidate domain website screenshots and a perceptual hash from each of the one or more seed domain website screenshots. Then, for each pair of a candidate perceptual hash and a seed perceptual hash, the system calculates a similarity between the perceptual hashes. The closer the perceptual hashes are in a pair, the closer to each other are the corresponding screenshots for the pair. In some implementations, if the similarity is greater than a threshold, the system classifies the candidate domain as an impersonating domain. In some other implementations, screenshots of conflicting domains are also captured and used to generate perceptual hashes. As such, classifying the candidate domain is based on the similarity between a candidate perceptual hash and each of the conflicting perceptual hashes. In response to identifying a conflicting domain (such as an impersonating domain), the system may generate a notification (such as an instant message) to notify users or system security that new potential threats have been identified. In addition, the system may add any newly identified conflicting domains to the set of previously identified conflicting domains (such as adding the domain's screenshots to a database of screenshots of previously identified conflicting domains, adding newly generated perceptual hashes, and so on), with the new set of conflicting domains used in the analysis of future candidate domains.

Various implementations of the subject matter disclosed herein provide one or more technical solutions to internet security in regards to online services (such as the identification and notification of phishing platforms and other types of conflicting domains for seed domains and their online services accessed via a digital communication medium (such as via the internet)). As such, various aspects of the present disclosure provide a unique computing solution to a unique computing problem that did not exist prior to the internet and such online services. In addition, the thousands or more domains checked frequently (such as daily) is made possible through the use of perceptual hashes and cannot be performed in the human mind, much less practically in the human mind at such a frequency, even if pen and paper are used.

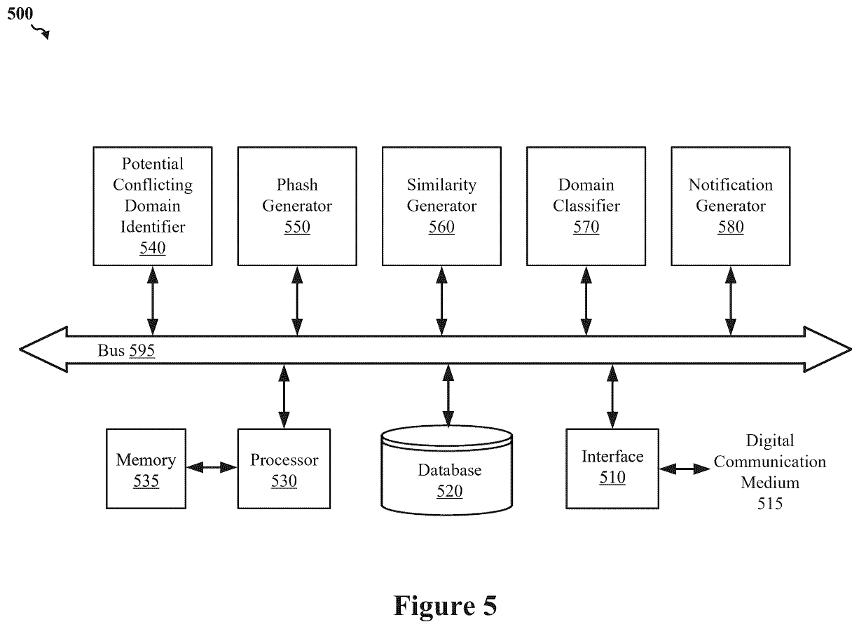

FIG. 5 shows an example system 500 for classifying internet domains and notifying of a conflicting internet domain, according to some implementations. The system 500 includes an interface 510 coupled to a digital communication medium 515, a database 520, a processor 530, a memory 535 coupled to the processor 530, a potential conflicting domain identifier (identifier) 540, a perceptual hash (phash) generator 550, a similarity generator 560, a domain classifier 570, and a notification generator 580. In some implementations, the various components of the system 500 may be interconnected by at least a data bus 595, as depicted in the example of FIG. 5. In other implementations, the various components of the system 500 may be interconnected using other suitable signal routing resources.

The interface 510 may be one or more input/output (I/O) interfaces to obtain, via the digital communication medium 515, screenshots of websites hosted by conflicting domains, candidate domains being analyzed, or one or more seed domains. The interface 510 may also obtain passive domain name system (DNS) data for the domains. The interface 510 may also provide notifications to users or others of identified impersonating domains, instructions for accessing one or more domains, phashes generated by the system 500, or a table of conflicting domain classifications to be used in future classifications. The interface 510 may also receive or provide inputs or outputs for continued operation of the system 500. An example interface 510 may include a wired interface or wireless interface to the internet to communicably couple with other devices (with the digital communication medium 515 being one or a combination of a wired medium or a wireless medium to connect the devices over the internet). In some implementations, the interface 510 may include an interface with an ethernet cable or a wireless interface to a modem, which is used to communicate with an internet service provider (ISP) directing traffic to and from other devices. For example, the system 500 may access one or more domain hosts (servers) hosting websites of conflicting domains, candidate domains to be analyzed, or seed domains via a web browser, and the system 500 may capture a screenshot of the resulting webpages when accessing the websites using a screen capture tool. For the example of the seed domain name being intuit.com or mailchimp.com, the screenshots being captured or collected may be similar to the screenshots depicted in FIGS. 1-4. To note, while the screenshots depicted in FIGS. 1-4 are in grayscale, the screenshots captured by the system 500 may be in color as transmitted by the domain host hosting the website and to be displayed on a user display. Alternatively, the screenshots may be in grayscale (such as depicted in FIGS. 1-4) to reduce the processing required to perform a perceptual hash (phash) on each of the screenshots as described below with reference to the phash generator 550. In addition to capturing screenshots, in some implementations, the system 500 may access a domain lookup service via an application programming interface (API) to the service to identify whether a domain name is registered and, in some implementations, to obtain passive DNS data for a domain.

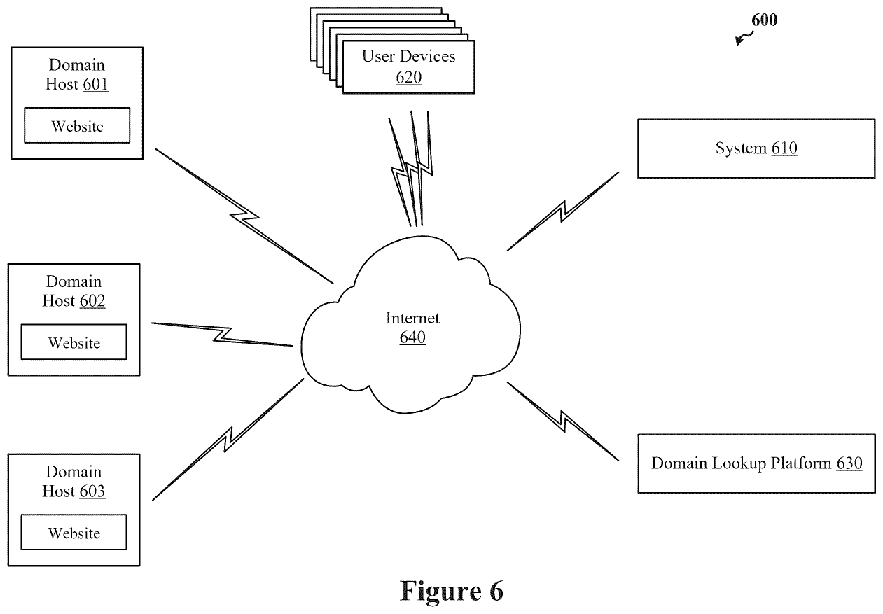

The system 500 is remote to user devices used to access a seed domain (such as a user personal computer (PC) used to access a seed domain website via the PC's web browser by a user entering the domain name into the URL bar of the web browser) or other user devices (such as a user's smartphone). The system 500 uses the interface 510 to transmit notifications to users over the digital communication medium 515, thus notifying users of impersonating domains that are identified by the system 500. The system 500 may also notify a security team in order for the security team to initiate steps to have the impersonating domain website taken down. The system 500 communicating with domain hosts, user devices, and a domain lookup service/platform via the digital communication medium 515 is described below with reference to FIG. 6.

Referring back to the interface 510 of the system 500 in FIG. 5, the interface may also include I/O peripherals for communicating with a local user (such as a security expert to monitor for phishing platforms), such as a display, mouse, keyboard, speakers, microphone, and so on.

The database 520 may store one or more of the screenshots received by the interface 510, the phashes generated by the phash generator 550, the similarities generated by the similarity generator 560, the domain classifications by the domain classifier 570, or the notifications generated by the notification generator 580. In some implementations, the database 520 stores a table indexing one or more of the stored screenshots, the phashes generated from the stored screenshots, or the previous classifications of conflicting domains associated with the stored screenshots, with the table used by the system 500 to identify conflicting domains to be compared to a candidate domain for classification. The table may also be used to retrieve the stored screenshots or phashes for comparison in classifying a candidate domain. The database 520 may also store other computer executable instructions or data for operation of the system 500. In some implementations, the database 520 may include a relational database capable of presenting information (such as candidate domain names, phashes, and classifications) as data sets in tabular form and capable of manipulating the data sets using relational operators. The database 520 may use Structured Query Language (SQL) for querying and maintaining the database 520.

The processor 530 may include one or more suitable processors capable of executing scripts or instructions of one or more software programs stored in system 500 (such as within the memory 535). For example, the processor 530 may be capable of executing one or more applications, the potential conflicting domain identifier 540, the phash generator 550, the similarity generator 560, the domain classifier 570, and the notification generator 580. The processor 530 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 530 may include a combination of computing devices (such as a combination of a DSP and a microprocessor, a plurality of microprocessors, one or more microprocessors in conjunction with a DSP core, or any other such configuration).

The memory 535, which may be a persistent memory (such as non-volatile memory or non-transitory memory) may store any number of software programs, executable instructions, machine code, algorithms, and the like that can be executed by the processor 530 to perform one or more corresponding operations or functions. For example, the memory 535 may store one or more applications, the potential conflicting domain identifier 540, the phash generator 550, the similarity generator 560, the domain classifier 570, and the notification generator 580 that may be executed by the processor 530. The memory 535 may also store inputs, outputs, or other information associated with the components 540-580 of the system 500 or any other data for operation of the system 500. In some implementations, hardwired circuitry may be used in place of, or in combination with, software instructions to implement aspects of the disclosure.

The potential conflicting domain identifier 540 is to identify internet domains to be analyzed for conflicting with a seed domain. The identifier 540 may include a typographical error (typo) crawler that generates domain names of potential domains to be analyzed based on a seed domain name input to the identifier 540. In some implementations, the typo crawler is a rule-based software program that receives the seed domain name as an input object, and the typo crawler alters the input seed domain name to generate variations of the input domain name as output domain names to be analyzed.

For example, the typo crawler may include one set of rules to perform substitution of one or more characters in the input domain name. The typo crawler thus substitutes a first character of the input domain name with one or more different characters to generate one or more output domain names, a second character of the input domain name with one or more different characters to generate one or more additional output domain names, and so on until the extension of the domain name is reached (such as reaching the .com or .net portion of the domain name). In some implementations, each alphanumeric character may be replaced with any other alphanumeric character in the substitution rule set. In some other implementations, the typo crawler may include mappings of the characters that may replace each specific character. For example, the mappings may be based on a qwerty or qwertz keyboard layout, and the characters for which a character may be substituted neighbor the character in the keyboard layout (based on a user mishitting the keyboard). For a qwerty keyboard, the character i may be replaced with each of the characters 8, u, j, k, o, and 9. Thus, if the input domain name to the typo crawler is “intuit.com,” in substituting the first character i, the typo crawler generates output domain names “8ntuit.com,” “untuit.com,” “jntuit.com,” “kntuit.com,” “ontuit.com,” and “9ntuit.com.” The typo crawler may also perform a similar process for characters n, t, u, i, and t. In addition to substituting characters, the substitution rule set may also include rules to substitute the extension with other available extensions. The typo crawler may include a mapping of extensions, with the extension (such as “.com”) being substituted for one or more different extensions (such as “.net,” “.org,” “.ca,” “.biz,” and so on).

In some implementations, the typo crawler performs substitutions on multiple characters. For example, in addition to substituting one character, the typo crawler may substitute two characters for each combination of two characters in the input domain name to generate additional output domain names. The typo crawler may also substitute the extension concurrently with one or more characters being substituted.

In addition to the substitution rule set, the typo crawler may include a set of rules to add characters beside existing characters in the input domain name to generate output domain names. In some implementations, based on the mappings of substitution characters for each character as described above, the typo crawler may iteratively insert, for each character of the input domain name, each of the characters in the mapping (which would be based on a user mishitting two keyboard keys when attempting to hit the intended key). For example, in the above mapping for character i being characters 8, u, j, k, o, and 9 and the input domain name being “intuit.com,” the typo crawler adds each of the mapped characters before or after character i to generate the output domain names “i8ntuit.com,” “iuntuit.com,” “ijntuit.com,” “ikntuit.com,” “iontuit.com,” “i9ntuit.com,” “8intuit.com,” “uintuit.com,” “jintuit.com,” “kintuit.com,” “ointuit.com,” and “9intuit.com.” The typo crawler may also perform the same process for each of the characters n, t, u, i, and t in the remainder of the input domain name. Similar to the substitution rule set, the addition rule set may be configured to cause the typo crawler to perform character addition for more than one character concurrently.

In addition to a substitution rule set and an addition rule set, the typo crawler may also include a set of rules to delete characters from the input domain name. A character being deleted is based on a user not hitting the keyboard key when typing in the domain name (such as not sufficiently striking the key or skipping the key altogether when typing). The typo crawler may delete each of the characters in the domain name in separate instances to generate a plurality of output domain names. For example, with the input domain name of “intuit.com,” the typo crawler may delete each of the characters i, n, t, u, i, and t to generate the output domain names “ntuit.com,” “ituit.com,” “inuit.com,” “intit.com,” “intut.com,” and “intui.com.” Similar to the substitution rule set and the addition rule set, the deletion rule set may be configured to cause the typo crawler to perform character deletion on more than one character concurrently.

In addition, the typo crawler may include a set of rules to swap characters in the input domain name. For example, the swapping rule set may cause the typo crawler to swap neighboring characters in the input domain name to generate a plurality of output domain names. For example, with the input domain name of “intuit.com,” the typo crawler may swap the character pairs i and n, n and t, t and u, u and i, and i and t to generate the output domain names “nituit.com,” “itnuit.com,” “inutit.com,” “intiut.com,” and “intuti.com.”

To note, the set of rules may also configure the typo crawler to perform character substitution, addition, deletion, and swapping concurrently. In addition, the rules may be adjusted to substitute, add, delete, and/or swap any number of characters or extensions concurrently based on, e.g., number of output domain names generated (such as up to a maximum number of output domain names desired), length of the input domain name, or other factors that may affect processing resources or time. For example, the typo crawler may be configured to generate a maximum of number of output domain names based on an input domain name, and increasing the number of concurrent character substitutions, additions, deletions, and swaps as well as the character length of the input domain name exponentially grows the number of output domain names. As such, the number of concurrent character substitutions, additions, deletions, and swaps may be a function of the character length of the input domain name and the maximum number of output domain names.

With the typo crawler generating a list of potential conflicting domain names that may be analyzed by the system 500, the system 500 may communicate with a domain lookup service/platform via the interface 510 and over the digital communication medium 515 to determine which domain names are registered. Additionally or alternatively, the system 500 may attempt to connect with one or more of the domains from the list of potential conflicting domain names to determine which domains are utilized. For the domains being utilized, the system 500 obtains screenshots for the websites hosted on the domains. The system 500 may also obtain passive DNS data from the domain lookup service for the utilized domains.

FIG. 6 shows an example network environment 600 for obtaining screenshots from conflicting domains, according to some implementations. The network environment 600 is shown to include three domain hosts 601-603, a conflicting domain identification system 610, a plurality of user devices 620, and a domain lookup platform 630 that are communicably coupled via the internet 640. Each domain host includes a server or network of servers to host one or more domains, including hosting at least one website to receive visitors to the one or more domains. To note, a plurality of domains may resolve to a single internet protocol (IP) address. For example, a company owning or sponsoring the domain host 601 may buy ten domain names, with the domain names resolving to a single IP address. As such, a visitor that types in any of the ten domain names is directed to the same website. In addition, various domain hosting businesses exist to host domains for those without the computing resources or desire to host on their own. As such, a network of servers of a domain host may host any number of different domains.

The system 610 is an example implementation of the system 500 in FIG. 5. As such, the system 610 identifies conflicting domains for a seed domain. User devices 620 are computing devices of users that visit the seed domain or are otherwise associated with users that visit the seed domain using other user devices 620. For example, for an Intuit customer (with the seed domain being intuit.com), user devices 620 may include the customer's personal computer, tablet, smartphone, or other electronic device communicably coupled to the internet 640. As described below, the internet 640 may be used by the system 610 to notify user devices 620 of an impersonating domain and to otherwise communicate with the user devices 620 (such as via a web portal, web page, or dedicated app on the user device to connect to the domain or an instant messaging app on the user device to receive notifications).

The domain lookup platform 630 includes a server or network of servers that may be accessed by the system 610 via the internet 640 to obtain electronic records of domain name registration data and passive DNS data for the domain. For example, the system 500 may store an application with an application programming interface (API) to receive the list of output domain names from the typo crawler. The output of the typo crawler may be an object including the list, with the object being ingestible by the API. In another example, the system 500 may access the domain lookup platform 630 via telnet over the internet 640 and provide the object to the domain lookup platform 630, with the domain lookup platform 630 responding with registration information and, in some implementations, the passive DNS data for each of the candidate domains names listed in the object. In some implementations, the passive DNS data includes a record for each domain name that is registered. The record may include the IP address or domain to which the domain resolves and how many domains resolve to the same IP address or domain (referred to as an IP count). The record may also include the number of visits to the website.

In some implementations, the domain lookup platform 630 includes a website scanner. The website scanner may visit websites and capture screenshots of one or more pages of each website. For example, the system 610 may communicate with the website scanner URLScan, which scans thousands of URLs daily, captures screenshots of the websites located at the URLs, and classifies the URLs. The website scanner (such as URLScan) may collect and classify URLs of potential phishing platforms submitted by the public or security groups, which may be collected in URL clearing houses, such as OpenPhish, PhishTank, and CertStream. The URLs may be classified according to the source URL that the URLs are attempting to impersonate or to be adjacent (such as via a typo in the URL). In some implementations, the system 610 may collect, from the website scanner, the domain names for such URLs classified by the website scanner for the seed domain. In this manner, the group of candidate domains to be analyzed may be expanded by the system 500 to include domain names missed by the typo crawler. While not depicted, the system 610 may also connect to the clearing houses or other domain registries to obtain domain data for the list of candidate domains to be analyzed.

Referring back to FIG. 5, with the domains to be analyzed identified (such as via a typo crawler generating domain names and a website scanner or clearing house identifying additional domain names) and the system 500 identifying which domain names are registered (such as via a domain lookup platform 630), the system 500 collects screenshots of the websites hosted at the registered domains. Referring back to FIG. 6, in some implementations, the digital screenshots collected by the domain lookup platform 630 (such as a website scanner) may be transmitted over the internet 640 to the system 610 for one or more domain names. The system 610 may also connect to domain hosts 601-603 hosting other domain names in the list generated by the identifier 540 to capture screenshots of the websites hosted at the hosts 601-603. For example, the system 610 may transmit the IP requests to receive one or more pages of a website at a domain host, and the system 610 receives the one or more pages in response. The system 610 may include a screen or display capture tool to capture the pages received. While three domain hosts are depicted in FIG. 6, any number of domain hosts may exist. Additionally or alternatively, while not depicted in FIG. 6, the system 610 may access the websites hosted at the domain hosts 601-603 via a proxy server, with the proxy server acting as a middleman for the system 610 to receive the web pages of the websites hosted at the domain hosts.

Collecting one or more screenshots of an internet website may include receiving a screenshot of a login page of the internet website. Since many phishing platforms attempt to collect login information from users, collecting screenshots of the login pages of websites at phishing platforms (impersonating domains) allows the system 500 to use the screenshots to identify impersonating domains that attempt to collect login information. Screenshots of web pages other than a login page may also be collected, such as an introduction page of the website.

With the screenshots collected, the system 500 may store the screenshots. In some implementations, the database 520 stores the screenshots, which are indexed to the domain names in the list of domain names that are to be analyzed or have been previously analyzed. The list may also include indications as to whether the corresponding domain was previously analyzed (either by the system 500 or a website scanner), whether an analyzed domain is a conflicting domain, and the type of the conflicting domain (such as whether the conflicting domain is an impersonating domain, a typosquatting domain, or an error domain). As noted above, the list may be a table that is sortable and searchable.

Referring back to FIG. 5, the phash generator 550 generates and outputs a perceptual hash (phash), which may also be referred to as a perceptual image hash, from an input image. The system 500 provides the screenshots to the phash generator 550, and the phash generator 550 generates a phash from each received screenshot. In some implementations, the phash generator 550 includes a discrete cosine transform (DCT) or convolutional neural network based fingerprint algorithm encoded in the Python programming language or another suitable language. To note, the fingerprint algorithm may express unique features of the seed domain screenshots in the phash. For example, logos, trademarks, or images may be uniquely identified in the phash such that comparison of phashes allows the system 500 to identify impersonating domains that attempt to appear official in the website without exactly impersonating the seed domain website. The system 500 may store the phashes in the table, with the phashes indexed to the associated domain names (and, in some implementations, the screenshots from which the phashes were generated). Each generated phash is a numerical vector, thus allowing the system 500 to manipulate the phashes via vector arithmetic or other mathematical means.

The similarity generator 560 calculates a similarity metric (which is referred to herein as a similarity) between two phashes. For example, the system 500 may provide a screenshot of the login page of the seed domain to the phash generator 550, with the generator 550 generating and outputting a seed phash. The system 500 may also provide a screenshot of the login page (if the login page exists) of a candidate domain to be analyzed to the phash generator 550, with the generator 550 generating and outputting a candidate phash. The similarity generator 560 may receive the seed phash and the candidate phash as inputs and generate a similarity between the phashes. As noted above, the phashes may be numerical vectors. Thus, the similarity between the phashes may be a distance metric between the numerical vectors. For example, the similarity calculated may be a cosine similarity between the phashes. In some implementations, the similarity is on a percentage scale from 0 to 100, with 100 indicating an exact match between the phashes.

A similarity between phashes indicates a similarity between screenshots. For example, two phashes having a similarity of 100 indicates that the corresponding screenshots are identical. As such, instead of comparing pixel values between screenshots, which may require more complicated mathematical processes and large amounts of processing resources for a large number of domains to be analyzed, the system 500 may compare phashes associated with the screenshots to determine the similarity between screenshots.

As noted in the example above, the similarity generator 560 may calculate similarities between phashes associated with the screenshots of the seed domain and screenshots of the candidate domain. Generating similarities for the current websites of the seed domain and the candidate domain allows the system 500 to identify impersonating domains that host websites impersonating the current website of the seed domain. However, those similarities are not as helpful in identifying whether the candidate domain is a different type of candidate domain, such as a typosquatting domain or an error domain. The similarities are also not as helpful in identifying whether the candidate domain is an impersonating domain of a previous version of the website of the seed domain. For example, the candidate domain may impersonate a previous version of the seed domain website before the website was updated. As such, the similarity generator 560 may generate additional similarities for the candidate domain to identify different types of conflicting domains or impersonating domains for different versions of the seed domain website. In some implementations, the similarity generator 560 may calculate similarities between screenshots of the seed domain and screenshots of previously classified conflicting domains, including previously classified impersonating domains, previously classified typosquatting domains, and previously classified error domains.

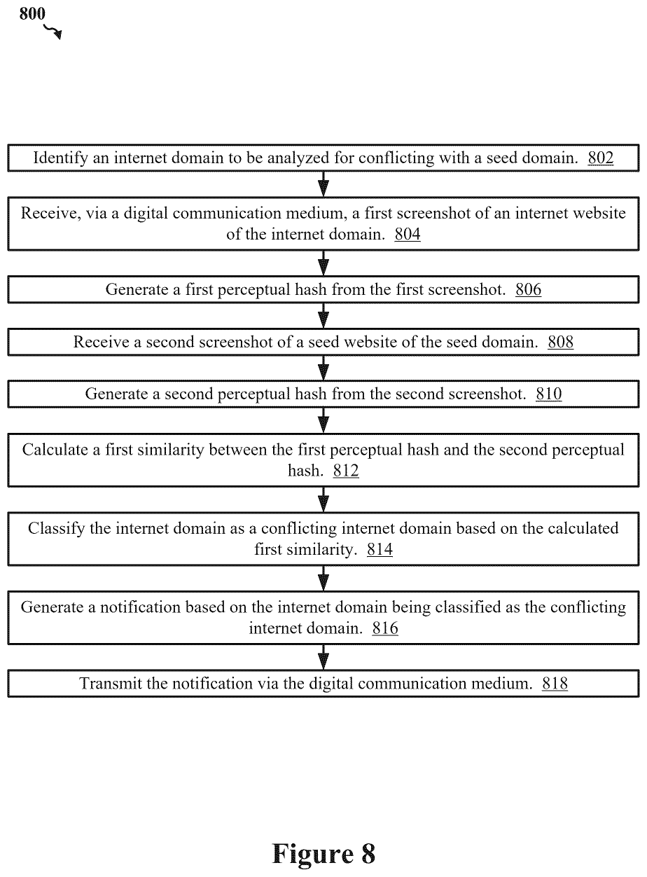

The domain classifier 570 classifies the candidate domain based on the calculated similarities from the similarity generator 560. For example, the domain classifier 570 may identify whether the similarity between the candidate phash and the seed phash is greater than a threshold. If the similarity is greater than the threshold, the domain classifier 570 classifies the candidate domain as an impersonating domain. If a plurality of similarities are generated (such as based on a plurality of previously classified conflicting domains), the domain classifier 570 may identify the maximum similarity from the plurality of similarities and classify the candidate domain as the domain type associated with the maximum similarity. For example, if the maximum similarity is associated with an impersonating domain or the seed domain, the domain classifier 570 may classify the candidate domain as an impersonating domain. If the maximum similarity is associated with a typosquatting domain, the domain classifier 570 may classify the candidate domain as a typosquatting domain. If the maximum similarity is associated with an error domain, the domain classifier 570 may classify the candidate domain as an error domain. The domain classifier may also compare the maximum similarity to a similarity threshold (such as greater than 80 on the above example scale of 0 to 100). If the maximum similarity is greater than the threshold, the domain classifier 570 continues with classifying the candidate domain as the domain type associated with the maximum similarity. If the maximum similarity is less than the threshold, the domain classifier 570 may prevent classifying the candidate domain. In some implementations, the domain classifier 570 defaults to classifying the candidate domain as an error domain if the maximum similarity is less than the threshold. Alternatively, the domain classifier 570 may default to classifying the candidate domain as a typosquatting domain if the maximum similarity is less than the threshold. Example implementations of classifying a candidate domain are described in more detail below with reference to FIGS. 8-12.

The notification generator 580 generates a notification based on the candidate internet domain being classified as a conflicting internet domain. In some implementations, the notification generator 580 is to generate notifications to alert users of an identified phishing platform (i.e., the candidate domain being classified as an impersonating domain). For example, an instant message application having an API may be executed by the system 500, and the notification generator 580 may generate an instant message notification using the API, with the notification being transmitted using the instant message application via the interface 510 and through the digital communication medium 515. In a specific example, the Slack instant messaging application from Slack Technologies, LLC, may be stored on and executed by the system 500, and the notification generator 580 may generate a Slack message that is to be delivered to a group list of contacts (e.g., users subscribed to a group) that are to be warned of newly identified phishing platforms. The notification generator 580 may also generate automatic emails to those contacts as well as alerts to security personnel (such as via the internet or an internal messaging network) responsible for initiating the takedown of the website on the impersonating domain.

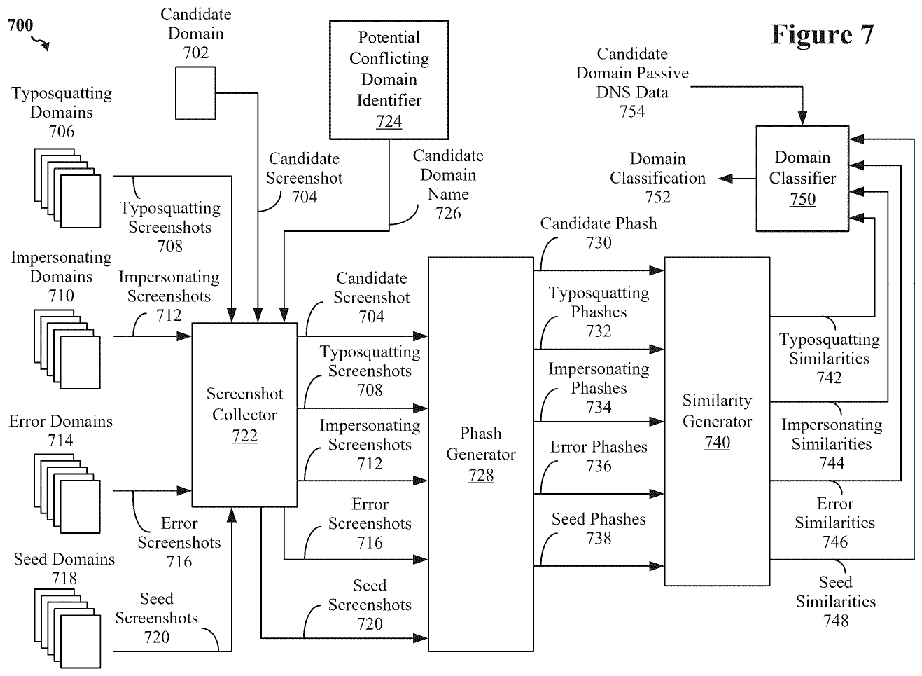

After a candidate domain is classified for the first time, the system 500 may also store the classification, such as in the table of domain names stored in the database 520. In some implementations, the candidate domains to be analyzed periodically (such as daily) include the typosquatting domains and the error domains included in the table. In this manner, the system 500 is able to track whether any of the previously classified conflicting domains are later converted into impersonating domains. As such, the candidate domains to be analyzed may include domain names that are newly generated domain names and previously analyzed domain names. Example operation of the system 500 is described in more detail below with reference to FIG. 7.

While the potential conflicting domain identifier 540, the phash generator 550, the similarity generator 560, the domain classifier 570, and the notification generator 580 are depicted as separate components of the system 500 in FIG. 5, the components 540-580 may be included in software including instructions stored in memory 535 or the database 520, may include application specific hardware (e.g., one or more ASICs), or a combination of the above. As such, the particular architecture of the system 500 shown in FIG. 5 is but one example of a variety of different architectures within which aspects of the present disclosure may be implemented. In addition, in other implementations, components of the system 500 may be distributed across multiple devices, may be included in fewer components, and so on. If the components are software, the components may be implemented using any suitable computer readable language. For example, each of the components 540-580 and the configuration and interoperability of such components with any APIs of other programs may be programmed in the Python programming language using any suitable libraries.

FIG. 7 shows an example block diagram 700 for classifying a domain, according to some implementations. In some implementations, the block diagram 700 is implemented in the system 500 depicted in FIG. 5, such as in components 540-570 of system 500. In block diagram 700, the potential conflicting domain identifier 724 is an example implementation of the potential conflicting domain identifier 540 in FIG. 5, the phash generator 728 is an example implementation of the phash generator 550 in FIG. 5, the similarity generator 740 is an example implementation of the similarity generator 560 in FIG. 5, and the domain classifier 750 is an example implementation of the domain classifier 570 in FIG. 5. While not depicted in FIG. 5, the screenshot collector 722 may be included in another component of system 500 in FIG. 5, such as the potential conflicting domain identifier 540, or as a separate component of system 500 in FIG. 5.

The block diagram 700 is depicted with reference to the system 500 comparing one web page of one candidate domain 702 to one or more seed domains 718 and, in some implementations, one or more conflicting domains (including typosquatting domains 706, impersonating domains 710, and error domains 714). However, the process depicted in block diagram 700 is iterated for any number of candidate screenshots 704 captured from a candidate domain 702 and any number of candidate domains 702 identified via candidate domain name 726 by the potential conflicting domain identifier 724. In some implementations, the identifier 724 obtains candidate domain names 726 from a domain name list or table stored in the database 520. As noted above, the domain name list or table (referred to herein as a table) may include previously generated domain names by the identifier 724 (such as by a typo crawler). The domain name list may also include previously classified conflicting domain names and, in some implementations, other conflicting domain names identified by, e.g., one or more website scanners or clearing houses.

As depicted in FIG. 7, the screenshot collector 722 receives the candidate screenshots 704 from a candidate domain 702 website, with the candidate domain 702 to be analyzed being identified by the potential conflicting domain identifier 724 (such as based on the list of domain names stored in the database 520 or newly generated domain names by a typo crawler). The screenshot collector 722 also receives seed screenshots 720 from one or more seed domains 718 to be compared with the candidate domain 702. In some implementations, the screenshot collector 722 also collects typosquatting screenshots 708 from typosquatting domains 706, impersonating screenshots 712 from impersonating domains 710, and error screenshots 716 for error domains 714.

The screenshot collector 722 may obtain a screenshot by connecting to a domain host website and capturing a screenshot of a webpage of the website (such as a login page or an introduction page, which refers to the first page accessed when using the domain name). Additionally or alternatively, the screenshot collector 722 may connect to the domain hosts via a proxy server to capture the screenshots, and/or the screenshot collector 722 may connect to a website scanner and request and receive the screenshots from a website scanner that regularly scans the websites. For example, the screenshot collector 722 attempts to access the candidate domain 702 website via the domain name pointing to a specific IP address for the website, and the screenshot collector 722 captures a screenshot of the introduction page of the website and a login page of the website, if they exist. If the domain name is not utilized or does not lead to an active webpage (which may indicate that the domain is an error domain), the screenshot collector captures a screenshot of the error message, such as the HTTP 404 error message in the web browser used by the system 500 for accessing domain websites. If there is no login page (such as for typosquatting domain websites that only have a basic one page website, such as depicted in FIG. 3), the screenshot collector may capture only the introduction page of the website (which may be the only page of many typosquatting domain websites).

The screenshot collector 722 obtains a candidate screenshot from a candidate domain host (either directly or via a proxy) each time a candidate domain is identified as to be analyzed. However, other screenshots to be used for comparison (such as from the seed domains 718 and conflicting domains 706, 710 and 714) may have been previously collected and stored by the system 500 such that those domain hosts do not need to be accessed again. For example, if 10,000 candidate domains are to be analyzed daily, a seed screenshot may be captured once daily from the seed domain host website, with the seed screenshot used in the analysis of each of the 10,000 candidate domains. For the previously classified conflicting domains (which was either by the system 500 or a website scanner or clearing house), the previously captured screenshots of the conflicting domain websites stored by the system 500 may be used in the analysis of each of the 10,000 candidate domains.

Alternatively, the phashes generated by the phash generator 728 for the previously classified conflicting domains and the seed domain during previous analysis of candidate domains, which may be stored in a table or list in the database 520, may be used for comparison, thus alleviating the need to again obtain the screenshots and generate new phashes. As such, the system 500 stores a set of phashes for conflicting domains to be compared to a phash for a candidate domain in classifying the candidate domain (such as the table or list stored in the database 520, as described above).

The phash generator 728 generates a phash from each of the candidate screenshot 704, the seed screenshots 720, and, in some implementations, the conflicting screenshots (which includes the typosquatting screenshots 708, the impersonating screenshots 712, and the error screenshots 716). As such, the phash generator 728 generates a candidate phash 730 from the candidate snapshot 704, a typosquatting phash 732 from each of the typosquatting screenshots 708, an impersonating phash 734 from each of the impersonating screenshots 712, an error phash 736 from each of the error screenshots 716, and a seed phash from each of the seed screenshots 720. The phash generator 728 may only need to generate a phash one time for each screenshot. As such, previously generated phashes for seed domain website screenshots and conflicting domain website screenshots may be stored and used later in the analysis of each candidate domain 702. To note, though, the potential conflicting identifier 724 may indicate typosquatting domains 706 and, in some implementations, error domains 714 as candidate domains for analysis (such as daily). As such, the screenshot collector 722 collects typosquatting screenshots 708 from the previously classified typosquatting domains 706 and, in some implementations, error screenshots 716 from the previously classified error domains 714 each time those domains are candidate domains for analysis by the system 500 (such as in monitoring those domains to identify if any have been converted to impersonating domains). The seed domain website screenshots 720 may be captured in the analysis of each batch of candidate domains 702 to be analyzed (such as daily if the system 500 analyzes candidate domains at a daily frequency). In such an example, the seed phashes 738 are generated by the phash generator 728 daily from the seed screenshots 720, which are also captured daily. Alternatively, the seed screenshots 720 may be captured and the seed phashes 738 may be generated when the seed domain website is updated, thus reducing the frequency at which seed screenshots are captured and seed phashes are generated. To note, current and previous seed phashes may be provided to the similarity generator 740 for the system to identify whether the candidate domain 702 is impersonating the current seed domain website or a previous version of the seed domain website. For example, the table in the database 520 may store seed phashes for a defined amount of time (such as two years). In this manner, the seed phashes of any version of the website over the last two years may be used in attempting to identify an impersonating website.

For a domain previously classified as an impersonating domain 710, no additional impersonating screenshots 712 may be captured and no additional impersonating phashes 734 may be generated. For example, a candidate domain may be classified as an impersonating domain based on the candidate phash being similar to an impersonating phash or a seed phash. As such, the candidate domain name may be stored by the system 500 as an impersonating domain in the table along with the phash and similarity generated and used to classify the domain as an impersonating domain. The impersonating phash is then used in future analysis of other candidate domains to determine whether the impersonating phash is similar to the new candidate phash in classifying the new candidate phash.

In some other implementations, the system may analyze impersonating domains 710 to identify whether the impersonating domains are still impersonating domains (such as whether the websites have yet been taken down or the websites converted back to typosquatting domains). As such, screenshots of the previously classified impersonating domains 710 may be obtained by the screenshot collector 722 if a previously classified impersonating domain is the candidate domain 702.

The similarity generator 740 calculates a similarity between the candidate phash 730 and the seed phash 738 to generate a seed similarity 748. The calculation may be performed for each pairing of the candidate phash 730 and each seed phash 738. The similarity generator 740 may also calculate a similarity between the candidate phash 730 and each of the conflicting phashes, including a typosquatting similarity 742 for each pairing of the candidate phash 730 and each of the typosquatting phashes 732, an impersonating similarity 744 for each pairing of the candidate phash 730 and each of the impersonating phashes 734, and an error similarity 746 for each pairing of the candidate phash 730 and each of the error phashes 736. As noted above, the similarity may be a distance metric between numerical vectors, such as a cosine similarity.

The domain classifier 750 thus generates a domain classification 752 based on the seed similarity 748 and, in some implementations, one or more of the typosquatting similarities 742, the impersonating similarities 744, and the error similarities 746. In a simplified example, the domain classifier 750 may compare the seed similarity 748 to a similarity threshold. If the seed similarity 748 is greater than the threshold, the domain classifier 750 classifies the candidate domain 702 as an impersonating domain. If the seed similarity 748 is less than the threshold, the domain classifier 750 prevents classifying the candidate domain 702 as an impersonating domain. In another example, the domain classifier 750 identifies the maximum similarity across all impersonating similarities 744 and seed similarities 748 and compares the maximum similarity to the threshold. In a further example, the domain classifier 750 identifies the maximum similarity across all similarities 742-748. The domain classifier 750 then classifies the candidate domain 702 as the type of domain associated with the maximum similarity. Examples of classifying a candidate domain are described below with reference to FIGS. 8-12.

In some implementations, the domain classifier 750 also classifies a candidate domain 702 based on the candidate domain passive DNS data 754. As noted above, the system 500 may obtain passive DNS data from a domain lookup platform (such as a website scanner, such as URLScan), and the system 500 may also store the passive DNS data for conflicting domains. For example, each time a previously classified typosquatting domain is a candidate domain for analysis, the system 500 requests and receives the IP count (and, in some implementations, the IP address) for the typosquatting domain. Typically for typosquatting domains, a large number of typosquatting domains are hosted by a domain host under a single IP address. Many times, the domain host is contracted by one or more parties to host each party's different domains, with those domains resolving to a single IP address. As such, the IP count for a typosquatting domain is higher than for other types of conflicting domains, especially impersonating domains. When a typosquatting domain is typically converted to an impersonating domain, the domain host changes for the typosquatting domain (such as from a reputable domain host to a new domain host configured to host a phishing platform). As such, the IP count for the domain name decreases (since much fewer domain names will resolve to the IP address of the phishing platform). The IP address to which the domain name resolves may also change.

In some implementations, the domain classifier 750 calculates a change between the current IP count and the previous IP count when the typosquatting domain was last analyzed (such as from the previous day). Additionally or alternatively, the domain classifier 750 compares the current IP address and the previous IP address of the typosquatting domain to identify any changes in the IP address. In addition to an impersonating similarity being greater than a similarity threshold or otherwise being used to identify a previously classified typosquatting domain as an impersonating domain, if the reduction in the IP count for the domain is greater than a threshold and, in some implementations, if the IP address changes, the domain classifier 750 classifies the previously classified typosquatting domain as an impersonating domain.

While not depicted in FIG. 7, the system 500 may generate a notification based on the domain classification 752 indicating a conflicting domain. In some implementations, in response to the domain classification 752 being an impersonating domain classification (thus indicating that the candidate domain 702 is a phishing platform), the notification generator 580 generates and transmits a notification (such as an instant message) to one or more user devices via the internet.

Example operations for classifying a candidate domain are described below with reference to FIGS. 8-12. As noted above, the system 500 may classify thousands or tens of thousands of candidate domains daily, which may include keeping track of typosquatting domains and, in some implementations, error domains to identify whether any of those domains are converted into impersonating domains. Thus, while the example operations depicted in the flowcharts in FIGS. 8-12 and described below are with reference to classifying a single domain for clarity, the operations may be performed for a large set of candidate domains. Since the calculation of similarities from phashes are used to compare domain websites and thus classify candidate domains, the computing system 500 is able to expeditiously classify a large number of candidate domains (such as tens of thousands of candidate domains) frequently (such as daily).

FIG. 8 shows an illustrative flow chart of an example operation 800 of classifying an internet domain and notifying of a conflicting internet domain, according to some implementations. The example operation 800 is described as being performed by the system 500 in FIG. 5, with the block diagram 700 in FIG. 7 being an example configuration of the system 500.

At 802, the system 500 identifies an internet domain to be analyzed for conflicting with a seed domain. For example, the system 500 provides an input domain name of a seed domain (such as intuit.com) to a typo crawler of the potential conflicting domain identifier 540. The typo crawler generates an initial list of domain names of candidate domains to be analyzed (such as intuit.net, ntuit.com, intuitr.com, and so on). The system 500 may store the list of candidate domain names in a table in database 520. For example, the table includes a row for each candidate domain name, with one column storing the domain name, one column storing an indication (such as a bit flag) as to whether the corresponding domain is a conflicting domain, one column storing an indication as to the type of conflicting domain, and one or more columns storing one or more phashes previously generated for the domain. In some implementations, the table may also include one or more columns to store passive DNS data for the domain, such as one column storing an IP count for the domain and, in some implementations, one column storing an IP address to which the domain name resolves. As noted above, the table of domain names stored in the database 520 may be expanded by the system 500 to include additional domain names listed in clearing houses or identified by website scanners as being associated with the seed domain after the system 500 connects to such clearing houses and website scanners via the internet. The potential conflicting domain identifier 540 may thus identify an internet domain as a candidate domain to be analyzed in step 802 by accessing the table in the database 520 and retrieving the domain name of a next row in the table of a domain that has not been previously identified as an impersonating domain. To note, the system 500 may analyze each of such domains in the table periodically (such as daily) to identify impersonating domains within a short period of time after launch of such domains (such as within 24 hours). As such, the system 500 may progress through the table of domain names, e.g., daily to analyze each of the domain names.

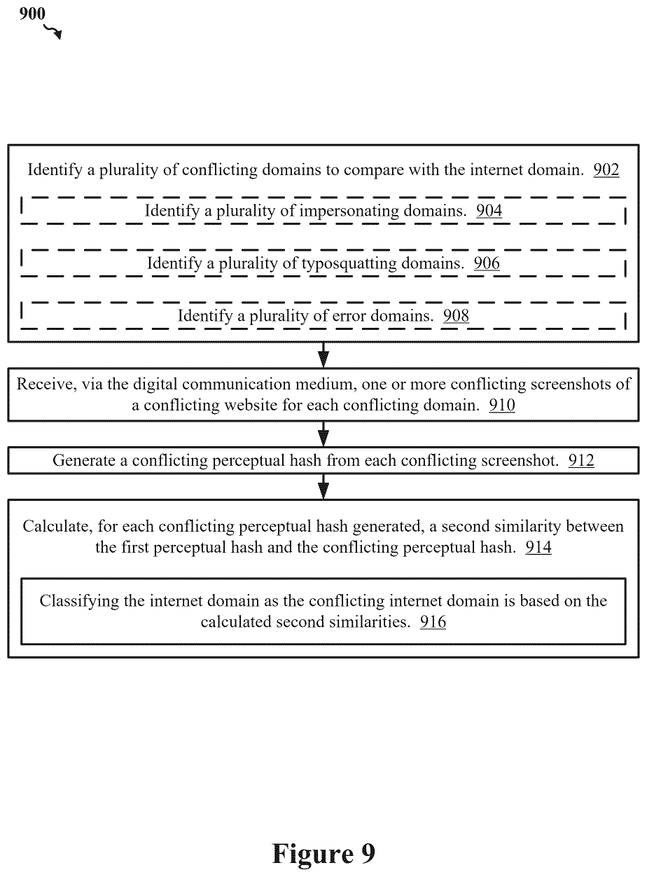

At 804, with the internet domain to be analyzed identified, the system 500 receives, via the digital communication medium 515, a first screenshot of an internet website of the internet domain. For example, the system 610 accesses a domain name system (DNS) via the internet 640 and obtains an IP address from the DNS that links the domain name to the IP address of the domain host for the domain name. The system 610 may access the domain host using the IP address or may access the domain host via a proxy server, and the system 610 captures the first screenshot. In some implementations, the first screenshot includes a screenshot of a login page of the candidate domain website located at the IP address. Additionally or alternatively, the first screenshot may include a screenshot of an introduction page of the website (i.e., a landing page). To note, while FIG. 8 (as well as FIG. 9-12) are depicted with reference to a single screenshot from a candidate domain for clarity in exampling aspects of the present disclosure, the system 500 may capture a plurality of screenshots from a plurality of different pages of the candidate domain website, with each screenshot to be used in comparing the candidate domain to a seed domain (or one or more conflicting domains). The screenshot may be of a suitable size (such as a fixed size of a first number of rows of a web page, the entirety of the web page, or a fixed window size within the web page), and the screenshot may include a suitable representation of the pixel values of the web page (such as the original pixel values as transmitted by the domain host, a grayscale version of the pixel values, or a compressed version of the pixel values that does not lose the required features of the image for generating a phash by the phash generator 550).

At 806, the system 500 generates a first phash from the first screenshot. For example, the system 500 provides the candidate screenshot 704 collected by the screenshot collector 722 in step 804 to the phash generator 728, which has encoded a fingerprint algorithm to convert images into phashes. The phash generator 728 thus generates the candidate phash 730 from the candidate screenshot 704.

At 808, the system 500 receives a second screenshot of a seed website of the seed domain. For example, the system 610 may connect to a domain host that hosts the seed website of the seed domain via the internet 640 and capture a screenshot of the seed website. The means of capturing a screenshot of the seed website of the seed domain in step 808 may be similar to the means of capturing a screenshot of the internet website of the internet domain being analyzed as in step 804. In some implementations, the second screenshot is of a login page of the seed website. Similar to as described above with reference to the candidate domain website, multiple screenshots of different web pages of the seed website may be captured by the system for comparing the candidate domain to the seed domain. For example, the second screenshots may include, in addition to a screenshot of the login page, a screenshot of the introduction page (i.e., landing page). As noted above, the system 500 analyzes a plurality of domain names periodically (such as daily). As such, once one or more seed screenshots are captured from the seed website for a first candidate domain to be analyzed, the seed screenshots may not be captured again for analysis of the other candidate domain during the same period of analysis (such as for that day if performed daily). Instead, the seed phashes generated from the seed screenshots may be stored (such as in the table in the database 520) and used in the analysis of other candidate domains. In some implementations, the database 520 may also store the screenshots captured, including the seed screenshots.

At 810, the system 500 generates a second phash from the second screenshots. For example, after the screenshot collector 722 captures the seed screenshot 720, the system 500 provides the seed screenshot 720 to the phash generator 728, and the phash generator 728 generates a seed phash 738 from the seed screenshot 720. As such, the system 500 may compare the internet domain identified in step 802 to the seed domain by comparing the first phash to the second phash.

At 812, the system 500 calculates a first similarity between the first phash and the second phash. As noted above, the phashes may be numerical vectors generated by the phash generator 728, with the numerical vectors identifying unique features of the screenshots based on the fingerprinting algorithm encoded in the phash generator 728. As such, the similarity generator 740 may generate the first similarity (such as a seed similarity 748) as a distance metric between the seed phash 738 and the candidate phash 730. For example, the first similarity may be a cosine similarity between the two numerical vectors. In another example, the first similarity may be a sum of the magnitude of the differences of corresponding entries between the numerical vectors.

At 814, the system 500 classifies the internet domain as a conflicting internet domain based on the calculated first similarity. For example, the domain classifier 750 classifies the candidate domain 702 based on the seed similarity 748 generated by the similarity generator 740 in step 812. For example, the domain classifier 750 may compare the seed similarity 748 to a similarity threshold (such as a threshold of 80 for similarities on a percentage scale from 0 to 100). The seed similarity 748 being greater than the similarity threshold indicates that the candidate screenshot 704 is similar enough to the seed screenshot 720 that the candidate domain 702 is impersonating the seed domain 718. As such, the domain classifier 750 may classify the candidate domain 702 as an impersonating domain. Other examples of classifying the candidate domain, including comparing the candidate domain to conflicting domains, are described in more detail below with reference to FIGS. 9-12.

At 816, the system 500 generates a notification based on the internet domain being classified as the conflicting domain (such as an impersonating domain). At 818, the system 500 transmits the notification via the digital communication medium 515. For example, in response to the domain classification 752 indicating that the candidate domain 702 is an impersonating domain, the notification generator 580 generates an instant message notification (such as a Slack message) to be transmitted to users of the seed domain. The system 500 then transmits the message to a plurality of user devices (such as via the internet 640 to user devices 620). For example, the users wishing to receive such notifications may subscribe his or her user devices 620 to receive the messages via a Slack service subscription list, and the system 610 transmits the message generated at step 816 to the user devices in the subscription list using the Slack service at step 818. If analysis of candidate domains is performed daily, users may be notified of specific impersonating domains within 24 hours of those domains impersonating the seed domain.

While not depicted in FIG. 8, the system 500 may update the table stored in the database 520 to include the domain classification 752 for the candidate domain 702. In this manner, the candidate domain 702 may be used for later classifications of other candidate domains after the candidate domain 702 has been classified via the domain classification 752 (such as being one of the conflicting domains 706, 710, and 714).

As noted above, in some implementations, classification of the candidate domain 702 as a conflicting domain is based on the use of one or more previously classified conflicting domains in addition to the seed domain 718. For example, the candidate domain 702 may be compared to conflicting domains to identify whether the website of the candidate domain 702 is more similar the website of one of the conflicting domains than websites of other conflicting domains or the seed website of the seed domain. Examples of the classification of the candidate domain based on one or more conflicting domains are described below with reference to FIGS. 9-12.

FIG. 9 shows an illustrative flow chart of an example operation 900 of classifying an internet domain, according to some implementations. Classification of the internet domain in the example operation 900 is based on a plurality of conflicting domains in addition to the seed domain as depicted in the example operation 800 in FIG. 8. As such, in some implementations, the example operation 900 is in addition to the example operation 800 in FIG. 8. The example operation 900 is described as being performed by the system 500 in FIG. 5, with the block diagram 700 in FIG. 7 being an example configuration of the system 500.

At 902, the system 500 identifies a plurality of conflicting domains to compare with the internet domain. In some implementations, a conflicting domain is one of an impersonating domain, a typosquatting domain, or an error domain. As such, identifying a plurality of conflicting domains in step 902 may include identifying a plurality of impersonating domains (904). Additionally or alternatively, identifying a plurality of conflicting domains in step 902 may include identifying a plurality of typosquatting domains (906). Additionally or alternatively, identifying a plurality of conflicting domains in step 902 may include identifying a plurality of error domains (908). For example, the table of domain names stored in the database 520 may indicate a plurality of impersonating domains, a plurality of typosquatting domains, and a plurality of error domains based on previous classifications of the domains (such as by the system 500 or, in some implementations, a clearing house or website scanner).

At 910, the system 500 receives, via the digital communication medium, one or more conflicting screenshots of a conflicting website for each conflicting domain. To note, if the system 500 previously classified a conflicting domain as a conflicting domain, the system 500 received the screenshots of the conflicting website when the conflicting domain was being classified. As such, receiving the one or more conflicting screenshots of the conflicting website in step 910 may refer to the system 500 receiving the conflicting screenshots when the conflicting domain was being previously classified (such as in step 804 of example operation 800 when the conflicting domain was the internet domain identified to be analyzed in step 802). If the screenshots for the conflicting website were not previously received by the system 500 (such as if a clearing house or website scanner classified the domain as a conflicting domain), the system 500 may receive the conflicting screenshots similar to as described above with reference to receiving a first screenshot in step 804 of example operation 800. For example, the system 610 may access the conflicting domain host directly or through a proxy server via the internet 640 and capture screenshots from one or more web pages of the conflicting website.

At 912, the system 500 generates a conflicting phash from each conflicting each screenshot. For example, from each conflicting screenshot 708, 712, and 716 collected by the screenshot collector 722, the phash generator 728 generates a conflicting phash. To note, if a conflicting domain was previously classified as a conflicting domain by the system 500, with the system 500 having previously received conflicting screenshots and generated conflicting phashes from the conflicting screenshots, the previously generated conflicting phashes may be stored in the table in the database 520. As such, the previously generated conflicting phashes may be used by the system 500 instead of generating new conflicting phashes. As such, generating a conflicting perceptual phash for a conflicting domain previously classified as a conflicting domain by the system 500 may refer to the system 500 generating one or more first phashes when the conflicting domain was being previously classified (such as in step 806 of example operation 800 when the conflicting domain was the internet domain identified to be analyzed in step 802). If the conflicting phashes were not previously generated (such as when the conflicting screenshots were not previously received by the system 500 because the conflicting domain was classified by a clearing house or website scanner), as noted above, the system 500 may receive the conflicting screenshots similar to as described above with reference to receiving a first screenshot in step 804 of example operation 800, and the system 500 may generate the conflicting phashes from the conflicting screenshots similar to as described above with reference to generating a first phash in step 806 of example operation 800. For example, the phash generator 550 may receive the one or more conflicting screenshots and generate the one or more conflicting phashes based on the fingerprint algorithm encoded in the phash generator 550.

At 914, the system 500 calculates, for each conflicting phash generated, a second similarity between the first phash (which is generated at step 806 of example operation 800) and the conflicting phash. For example, with a plurality of conflicting phashes stored in the table in the database 520, which may include the typosquatting phashes 732, the impersonating phashes 734, and the error phashes 736, the similarity generator 740 generates a plurality of conflicting similarities between the candidate phash and the plurality of conflicting phashes. Generating a second (conflicting) similarity in step 914 may be similar to generating the first similarity in step 812 of example operation 800. For example, the similarity generator 740 may calculate a distance metric between each unique pairing of the candidate phash 730 and a conflicting phash from the plurality of conflicting phashes.

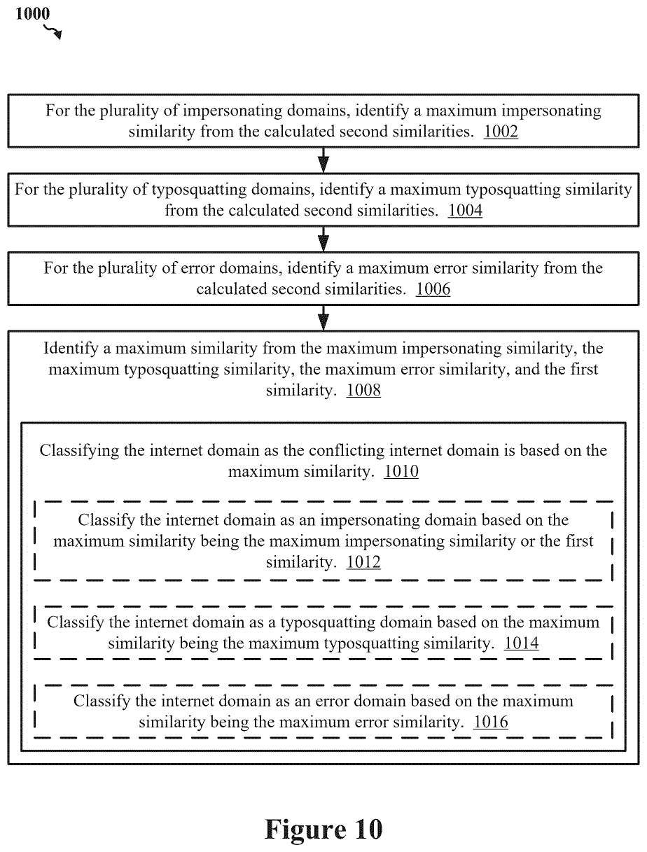

Classifying the internet domain as the conflicting internet domain (in step 814 of example operation 800) is thus also based on the calculated second similarities (916). For example, the system 500 may classify the internet domain as the same type of domain associated with the highest similarity across the first (seed) similarity and the second (conflicting) similarities. In another example, the system 500 may use a tiered approach to attempt to classify the internet domain as a first type of conflicting domain (such as an impersonating domain), then a second type of conflicting domain (such as an error domain), and then a third type of conflicting domain (such as a typosquatting domain). Alternatively, the tiered approach may include the second tier of conflicting domain being a typosquatting domain and the third tier of conflicting domain being an error domain. Examples of classifying the internet domain based on the calculated second similarities are described below with reference to FIGS. 10-12.

FIG. 10 shows an illustrative flow chart of an example operation 1000 of classifying an internet domain, according to some implementations. In the example operation 1000, classification of the internet domain is based on a maximum similarity across the second (conflicting) similarities and the first (seed) similarity. The example operation 1000 is an example implementation of step 814 of the example operation 800 in FIG. 8, with the example operation 800 and the example operation 900 in FIG. 9 both being performed. In addition, for the example operation 1000, substeps 904-908 of step 902 of the example operation 900 are performed. The example operation 1000 is described as being performed by the system 500 in FIG. 5, with the block diagram 700 in FIG. 7 being an example configuration of the system 500.

At 1002, the system 500 identifies, for the plurality of impersonating domains, a maximum similarity from the calculated second similarities. For example, if 50 impersonating domains are listed in the table stored in the database 520, and one impersonating phash of a login page is stored for each of the 50 impersonating domains in the table, the similarity generator 560 generates 50 impersonating similarities between the first (candidate) phash and the 50 stored impersonating phashes. As such, the domain classifier 570 identifies the highest impersonating similarity from the 50 impersonating similarities.

In some implementations, the plurality of impersonating similarities may also include the one or more first (seed) similarities. For example, as described with reference to FIG. 7 above, the similarity generator 740 may generate a plurality of impersonating similarities 744 and one or more seed similarities 748. Each impersonating similarity 744 indicates a similarity between the candidate phash 730 and an impersonating phash 734, which corresponds to a similarity between the candidate screenshot 704 and an impersonating screenshot 712 used to generate the impersonating phash 734. As such, a high similarity between the candidate phash 730 and an impersonating phash 734 indicates a high correlation between the candidate screenshot 704, and thus the candidate domain website, and the corresponding impersonating screenshot 712, and thus the impersonating domain website. If the similarity is high enough (such as the greatest similarity across all calculated similarities being an impersonating similarity 744 and/or the impersonating similarity 744 being greater than a similarity threshold), the system 500 (such as the domain classifier 750) identifies the candidate domain 702 as similar to the corresponding impersonating domain 710 (which has already been classified as an impersonating domain 710 of the seed domain 718) such that the candidate domain 702 is classified as an impersonating domain in the domain classification 752.

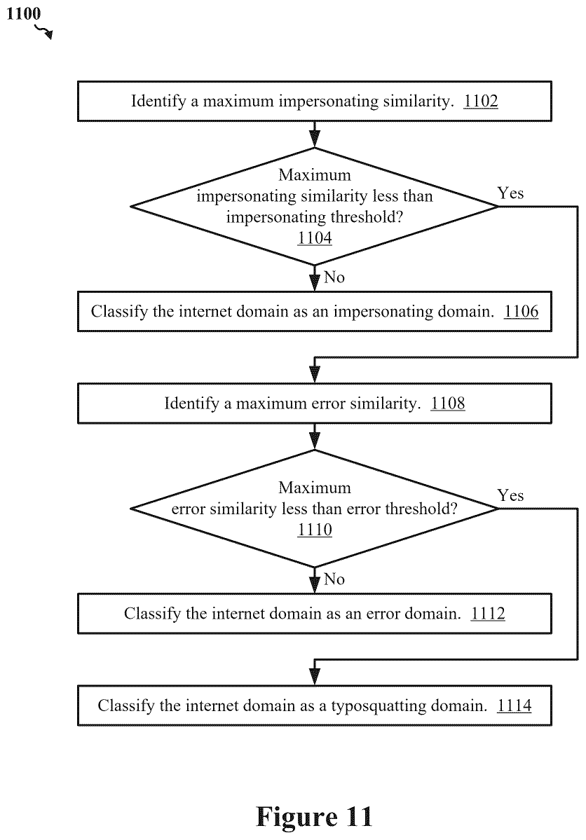

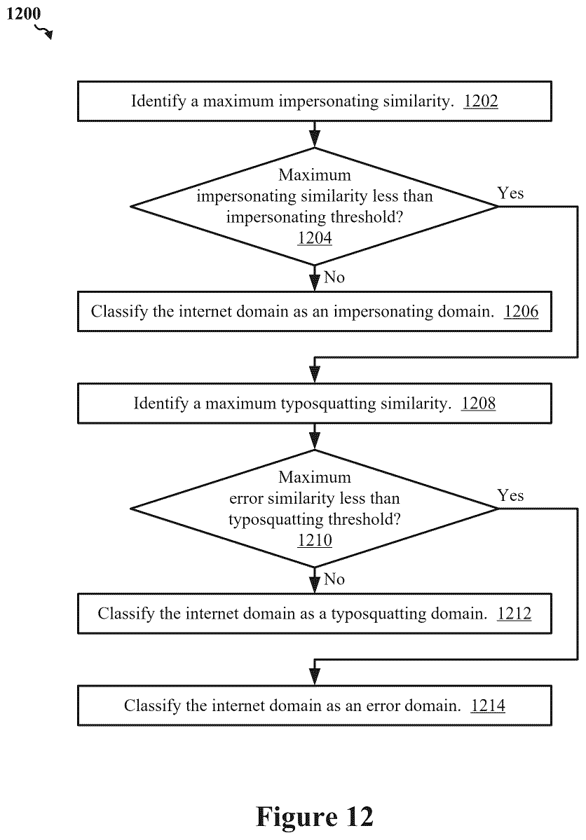

Also as noted above, a candidate domain 702 may be classified as an impersonating domain if a candidate screenshot 704 is similar to a seed screenshot 720. Similar to as described above for an impersonating similarity 744, a seed similarity 748 indicates a similarity between the candidate phash 730 and a seed phash 738, which corresponds to a similarity between the candidate screenshot 704 and a seed screenshot 720 used to generate the seed phash 738. As such, a high similarity between the candidate phash 730 and a seed phash 738 indicates a high correlation between the candidate screenshot 704, and thus the candidate domain website, and the corresponding seed screenshot 720, and thus the seed domain website. If the similarity is high enough (such as the seed similarity being the greatest similarity across all calculated similarities and/or the seed similarity being greater than a similarity threshold), the system 500 (such as the domain classifier 750) identifies the candidate domain 702 as impersonating the seed domain in the domain classification 752. As such, a seed similarity 748 and an impersonating similarity 744 may be used in a similar manner by the system 500 (such as by the domain classifier 750) to identify the candidate domain 702 as an impersonating domain. Hence, in some implementations, the plurality of impersonating similarities in step 1002 of the example operation 1000 (as well as in step 1102 of the example operation 1100 in FIG. 11 and in step 1202 of the example operation 1200 in FIG. 12) may include the one or more first (seed) similarities calculated in step 812 of the example operation 800 in FIG. 8.

At 1004, the system 500 identifies, for the plurality of typosquatting domains, a maximum typosquatting similarity from the calculated second similarities. For example, if 50 typosquatting domains are listed in the table stored in the database 520, and one typosquatting phash of a single page of the typosquatting domain website is stored for each of the 50 typosquatting domains in the table, the similarity generator 560 generates 50 typosquatting similarities between the first (candidate) phash and the 50 stored typosquatting phashes. As such, the domain classifier 570 identifies the highest typosquatting similarity from the 50 typosquatting similarities.

At 1006, the system 500 identifies, for the plurality of error domains, a maximum error similarity from the calculated second similarities. For example, if 50 error domains are listed in the table stored in the database 520, and one error phash of an error page is stored for each of the 50 error domains in the table, the similarity generator 560 generates 50 error similarities between the first (candidate) phash and the 50 stored error phashes. As such, the domain classifier 570 identifies the highest error similarity from the 50 error similarities.

At 1008, the system 500 identifies a maximum similarity from the maximum impersonating similarity, the maximum typosquatting similarity, the maximum error similarity, and the first similarity (if the first similarity is not included in the plurality of impersonating similarities for step 1002). Classifying the internet domain as the conflicting internet domain (at step 814 of the example operation 800 in FIG. 8) is thus based on the maximum similarity (1010). For example, at 1012, the system 500 may classify the internet domain as an impersonating domain based on the maximum similarity being the maximum impersonating similarity or the first similarity (if the first similarity is not included in the plurality of impersonating similarities for step 1002). At 1014, the system 500 may classify the internet domain as a typosquatting domain based on the maximum similarity being the maximum typosquatting similarity. At 1016, the system 500 may classify the internet domain as an error domain based on the maximum similarity being the maximum error similarity.

In some implementations, the system 500 may also compare the maximum similarity to a similarity threshold to ensure that the first screenshot is similar enough to the screenshot used to generate the maximum similarity such that the internet domain is to be classified as the conflicting domain corresponding to the maximum similarity. For example, if the seed domain name is intuit.com and the candidate domain name is inuit.com (such as generated by the typo crawler of the potential conflicting domain identifier 540), inuit.com is a domain name of a domain website for artwork from indigenous people of northern Canada (Inuits). As such, the candidate domain is not a conflicting domain and is instead its own legitimate domain. In performing the example operation 1000 for the candidate domain inuit.com, the maximum similarity associated with a screenshot from the candidate domain website may be one of, e.g., the impersonating similarities calculated by the system 500 for the candidate domain. However, the maximum similarity should be relatively low as compared to similarities calculated for other candidate domains previously classified as impersonating domains. Hence, the maximum similarity should be less than the similarity threshold to indicate that the associated candidate screenshot 704 and the associated impersonating screenshot 712 (or seed screenshot 720) are dissimilar and thus should not be used to classify the candidate domain. As such, the system 500 (such as the domain classifier 750) may prevent classifying the candidate domain 702 (such as by outputting a nullset domain classification 752 or a defined value indicating that the candidate domain 702 is not to be classified). In some implementations, the system 500 may notify a security member (such as via an instant message transmitted over the digital communication medium 515) of candidate domains 702 that are not classified by the system 500. In this manner, the security member may manually review the domain to determine whether the candidate domain name is to be removed from the table stored in the database 520 and manually delete the entry from the table if the domain name is to be removed. Alternatively, the system 500 may automatically delete the entry from the table stored in the database 520. The system 500 may also store a separate list of domains that were analyzed and not classified and thus removed from the table stored in the database 520. In this manner, the system 500 is able to track all of the domains analyzed over time.

In addition or alternative to the system 500 basing the classification of the candidate internet domain on a single maximum similarity across all of the calculated similarities, the system 500 may classify the candidate internet domain using a tiered approach based on an order of importance of the types of conflicting domains. Examples of such a tiered approach to classifying a candidate internet domain by the system 500 are described below with reference to FIGS. 11 and 12.

FIG. 11 shows an illustrative flow chart of an example operation 1100 of classifying an internet domain, according to some implementations. As compared to the classification of an internet domain in the example operation 1000 in FIG. 10 based on a single maximum similarity, the classification of an internet domain in the example operation 1100 is based on a tiered approach in which impersonating domains are of top importance, error domains are of a next importance, and typosquatting domains are of a final importance. The example operation 1100 is an example implementation of step 814 of the example operation 800 in FIG. 8, with the example operation 800 and the example operation 900 in FIG. 9 both being performed. In addition, for the example operation 1100, substeps 904-908 of step 902 of the example operation 900 are performed. The example operation 1100 is described as being performed by the system 500 in FIG. 5, with the block diagram 700 in FIG. 7 being an example configuration of the system 500.

At 1102, the system 500 identifies a maximum impersonating similarity. Step 1102 may be the same as step 1002 of the example operation 1000 in FIG. 10 and as described above. As such, in some implementations, the maximum impersonating similarity may be a maximum similarity across all of the impersonating similarities and the first (seed) similarity calculated for the internet domain.

With the maximum impersonating similarity identified, the system 500 may compare the maximum impersonating similarity to an impersonating threshold. An impersonating threshold is a similarity threshold to indicate whether the internet domain is similar to the corresponding impersonating domain or the seed domain such that the system 500 is to classify the internet domain as an impersonating domain. At decision block 1104, if the maximum impersonating similarity is not less than the impersonating threshold (such as the similarity being greater than or equal to the threshold), the system 500 classifies the internet domain as an impersonating domain (1106). If the maximum impersonating similarity is less than the impersonating threshold at decision block 1104, the system 500 prevents classifying the internet domain as an impersonating domain, and the process continues to step 1108. In continuing to step 1108, the system 500 is unable to identify an impersonating domain (or the seed domain itself) whose website is similar enough to the internet domain website to be able to classify the internet domain as an impersonating domain. As such, beginning at step 1108, the system 500 may attempt to classify the internet domain as an error domain.

At 1108, the system 500 identifies a maximum error similarity. Step 1108 may be the same as step 1006 of the example operation 1000 in FIG. 10 and as described above. With the maximum error similarity identified, the system 500 may compare the maximum error similarity to an error threshold. An error threshold is a similarity threshold to indicate whether the internet domain is similar to the corresponding error domain such that the system 500 is to classify the internet domain as an error domain. At decision block 1110, if the maximum error similarity is not less than the error threshold (such as the similarity being greater than or equal to the threshold), the system 500 classifies the internet domain as an error domain (1112). If the maximum error similarity is less than the error threshold at decision block 1110, the system 500 prevents classifying the internet domain as an error domain, and the process continues to step 1114. In continuing to step 1114, the system 500 is unable to identify an error domain associated with a screenshot of an error page that is similar enough to a screenshot for the internet domain to be able to classify the internet domain as an error domain.

In the example operation 1100, if the system 500 is unable to classify the internet domain as an impersonating domain or an error domain, the system 500 is configured to default to classifying the internet domain as a typosquatting domain. As such, at 1114, the system 500 classifies the internet domain as a typosquatting domain. In this manner, any internet domains that are otherwise unable to be classified based on the impersonating threshold and the error threshold are classified as a typosquatting domain by default.

In some other implementations, while not depicted in FIG. 11, the system 500 may also identify a maximum typosquatting similarity and compare the maximum typosquatting similarity to a typosquatting threshold (similar to as described above with reference to blocks 1102-1104 or to blocks 1108-1110), and the system 500 may classify the internet domain as a typosquatting domain only if the maximum typosquatting similarity is not less than the typosquatting threshold. In this manner, some internet domains may remain unclassified after performing the example operation 1100 including the additional undepicted steps.

The impersonating threshold, the error threshold, and the typosquatting threshold (if it exists) may be configured in the system 500 to be the same threshold or different thresholds based on a desired tolerance in attempting to identify conflicting domains as compared to the possibility of false positives if the thresholds are set too low. In some implementations, the impersonating threshold may be the lowest maximum impersonating similarity calculated across all of the previously classified impersonating domains or a defined amount less than the lowest maximum impersonating similarity calculated across all of the previously classified impersonating domains. The error threshold may be the lowest maximum error similarity calculated across all of the previously classified error domains or a defined amount less than the lowest maximum error similarity calculated across all of the previously classified error domains. If a typosquatting threshold exists, the typosquatting threshold may be the lowest maximum typosquatting similarity calculated across all of the previously classified typosquatting domains or a defined amount less than the lowest maximum typosquatting similarity calculated across all of the previously classified typosquatting domains.

As can be seen in FIG. 11, even if an error similarity or a typosquatting similarity is greater than the maximum impersonating similarity, the system 500 still attempts to classify the internet domain as an impersonating domain without reference to the error similarities and the typosquatting similarities. Similarly, if the system 500 is unable to classify the internet domain as an impersonating domain and even if a typosquatting similarity is greater than the maximum error similarity, the system 500 still attempts to classify the internet domain as an error domain without reference to the typosquatting similarities.

Alternative to evaluating error similarities before typosquatting similarities, such as in the example operation 1100 in FIG. 11, the system 500 may evaluate typosquatting similarities before error similarities. For example, if the system 500 is unable to classify an internet domain as a typosquatting domain, the system 500 may default to classifying the internet domain as an error domain. Alternatively, the system 500 may then evaluate the error similarities to attempt to classify the internet domain as an error domain.

FIG. 12 shows an illustrative flow chart of an example operation 1200 of classifying an internet domain, according to some implementations. As compared to the classification of an internet domain in the example operation 1100 in FIG. 11 based on a tiered approach in which impersonating domains are of top importance, error domains are of a next importance, and typosquatting domains are of a final importance, the tiered approach in the example operation 1200 includes impersonating domains of top importance, typosquatting domains of a next importance, and error domains of a final importance. As such, the difference between the example operation 1100 and the example operation 1200 is that the importance between typosquatting domains and error domains are flipped. The example operation 1200 is an example implementation of step 814 of the example operation 800 in FIG. 8, with the example operation 800 and the example operation 900 in FIG. 9 both being performed. In addition, for the example operation 1200, substeps 904-908 of step 902 of the example operation 900 are performed. The example operation 1200 is described as being performed by the system 500 in FIG. 5, with the block diagram 700 in FIG. 7 being an example configuration of the system 500.

At 1202, the system 500 identifies a maximum impersonating similarity. Step 1202 is the same as step 1102 in the example operation 1100. The system 500 also compares the maximum impersonating similarity to an impersonating threshold. At decision block 1204, if the maximum impersonating similarity is not less than the impersonating threshold (such as the similarity being greater than or equal to the threshold), the system 500 classifies the internet domain as an impersonating domain (1206). If the maximum impersonating similarity is less than the impersonating threshold at decision block 1204, the system 500 prevents classifying the internet domain as an impersonating domain, and the process continues to step 1208. Decision block 1204 is the same as decision block 1104 in the example operation 1100. Beginning at step 1208, the system 500 may attempt to classify the internet domain as a typosquatting domain (as compared to the example operation 1100, in which the system 500 would next attempt to classify the internet domain as an error domain).

At 1208, the system 500 identifies a maximum typosquatting similarity. Step 1208 may be the same as step 1004 of the example operation 1000 in FIG. 10 and as described above. With the maximum typosquatting similarity identified, the system 500 may compare the maximum typosquatting similarity to a typosquatting threshold. A typosquatting threshold is a similarity threshold to indicate whether the internet domain is similar to the corresponding typosquatting domain such that the system 500 is to classify the internet domain as a typosquatting domain. At decision block 1210, if the maximum typosquatting similarity is not less than the typosquatting threshold (such as the similarity being greater than or equal to the threshold), the system 500 classifies the internet domain as a typosquatting domain (1212). If the maximum typosquatting similarity is less than the typosquatting threshold at decision block 1210, the system 500 prevents classifying the internet domain as a typosquatting domain, and the process continues to step 1214. In continuing to step 1214, the system 500 is unable to identify a typosquatting domain associated with a screenshot of a typosquatting page that is similar enough to a screenshot for the internet domain to be able to classify the internet domain as a typosquatting domain.

In the example operation 1200, if the system 500 is unable to classify the internet domain as an impersonating domain or a typosquatting domain, the system 500 is configured to default to classifying the internet domain as an error domain. As such, at 1214, the system 500 classifies the internet domain as an error domain. In this manner, any internet domains that are otherwise unable to be classified based on the impersonating threshold and the typosquatting threshold are classified as an error domain by default.

In some other implementations, while not depicted in FIG. 12, the system 500 may also identify a maximum error similarity and compare the maximum error similarity to an error threshold (similar to as described above with reference to blocks 1108-1112 of the example operation 1100 in FIG. 11), and the system 500 may classify the internet domain as an error domain only if the maximum error similarity is not less than the error threshold. In this manner, some internet domains may remain unclassified after performing the example operation 1200 including the additional undepicted steps. Similar to as described above with reference to FIG. 11, the impersonating threshold, the typosquatting threshold, and the error threshold (if it exists) may be configured in the system 500 to be the same threshold or different thresholds.

In comparing the example operation 1100 and the example operation 1200, the system 500 attempts to classify the internet domain as an impersonating domain first in both tiered approaches. However, the example operations 1100 and 1200 diverge from each other afterwards in that the system 500 attempts to classify the internet domain as a typosquatting domain next in the example operation 1200. As such, if the system 500 is unable to classify the internet domain as an impersonating domain and even if an error similarity is greater than the maximum typosquatting similarity, the system 500 still attempts to classify the internet domain as a typosquatting domain without reference to the error similarities.

Various example implementations of classifying an internet domain as a conflicting domain are described above. While not depicted in any of the example operations depicted in the Figures (such as the example operations 900-1200 depicted in FIGS. 9-12), in some implementations, classifying an internet domain as an impersonating domain is also based on the passive DNS data for the internet domain. For example, classifying an internet domain as an impersonating domain may be based on the IP count or change in the IP count for the internet domain in addition to the similarity calculated between the first (candidate) phash and a second (seed) phash or an impersonating phash. As noted above, when an internet domain switches from being, e.g., a typosquatting domain to an impersonating domain, the IP count for the internet domain may drop. In some implementations, the IP address may also change.

Referring back to the example operation 800 in FIG. 8, in some implementations, the example operation 800 includes the system 500 receiving, via the digital communication medium 515, passive DNS data of the internet domain, wherein classifying the internet domain as the conflicting internet domain (such as an impersonating domain) is also based on the passive DNS data. As noted above, the passive DNS data includes an IP count indicating the number of domains resolving to one of a same host or a same IP address to which the internet domain resolves. For example, the system 610 may access the domain lookup platform 630 (such as a website scanner or a website clearing house) via the internet 640 and request the IP count for the internet domain name.

The example operation 800 may also include the system 500 calculating a change in IP count for the internet domain, wherein classifying the internet domain as the conflicting internet domain in step 814 includes classifying the internet domain as an impersonating domain based on the change in IP count. For example, the table of domains/domain names stored in the database 520 may store the IP count for conflicting domains previously classified by the system 500. If a typosquatting domain listed in the table in the database 520 is the candidate internet domain being analyzed, the previous IP count may thus be stored in the table. As such, the system 500 may calculate a difference between the current IP count obtained for the typosquatting domain and the previous IP count stored for the typosquatting domain. To tolerate some variance in the IP count over time, in some implementations, the system 500 may compare the difference to a threshold (such as a percentage threshold) to determine if the IP count drops by a threshold amount. For example, the threshold may be a 50 percent threshold. If the current IP count is less than 50 percent of the previous IP count, the system 500 may classify the domain as an impersonating domain. Otherwise, the system 500 may not change the classification of the domain (such as leaving the domain classified as a typosquatting domain).

The system 500 calculating and using a change in IP count is in addition to using the first similarity or a conflicting similarity to classify the internet domain as an impersonating domain. As such, the change in IP count may be used as a double check by the system 500 before classifying a previously classified typosquatting domain (or error domain) as an impersonating domain. For example, the system 500 may classify the internet domain as an impersonating domain only if an impersonating similarity is greater than a similarity threshold and the reduction in IP count is greater than an IP count threshold. If the IP count threshold is not met, the system 500 may prevent classifying the internet domain as an impersonating domain. Such an additional requirement regarding the change in IP count to classify an internet domain as an impersonating domain may be included in step 814 of the example operation 800 in FIG. 8, such as in step 1012 of the example operation 1000 in FIG. 10, in decision block 1104 of the example operation 1100 in FIG. 11, or in decision block 1204 of the example operation 1200 in FIG. 12. As noted above, the system 500 may store the obtained IP count for the internet domain in the table stored in the database 520 for later use or review.

As described herein, a computing system analyzes a large number of domains frequently to identify conflicting domains, such as new impersonating domains, corresponding to a seed domain. As a result, the system is able to automatically identify and notify users of potential phishing platforms quickly after launch of such platforms (such as within 24 hours after launch). With time being of the essence in having phishing platforms taken down, the system alerting a security team quickly after a phishing platform launches (such as within 24 hours) in order for the security team to begin the manual process of having an impersonating website be taken down improves user security of the seed domain. The system is also able to store information regarding each newly identified conflicting domain, which may then be used in the future analysis of candidate domains (thus increasing the robustness of the system to identify conflicting domains over time as more conflicting domains are identified).

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c. In addition, the term “document” may be used interchangeably with “electronic document” or “computer readable document” based on how used above.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer readable medium. The processes of a method or algorithm disclosed herein may be implemented in a processor-executable software module which may reside on a computer readable medium. Computer readable media includes both computer storage media and communication media including any medium that can be enabled to transfer a computer program from one place to another. A storage media may be any available media that may be accessed by a computer. By way of example, and not limitation, such computer readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer readable media. Additionally, the operations of a method or algorithm may reside as one or any combination or set of codes and instructions on a machine readable medium and computer readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles, and the novel features disclosed herein.

What is claimed is:

1. A computer-implemented method for classifying an internet domain and notifying of a conflicting internet domain, the method comprising:
identifying an internet domain to be analyzed for conflicting with a seed domain;
receiving, via a digital communication medium, a first screenshot of an internet website of the internet domain;
generating a first perceptual hash from the first screenshot;
receiving a second screenshot of a seed website of the seed domain;
generating a second perceptual hash from the second screenshot;
calculating a first similarity between the first perceptual hash and the second perceptual hash;
classifying the internet domain as a conflicting internet domain based on the calculated first similarity;
generating a notification based on the internet domain being classified as the conflicting internet domain; and
transmitting the notification via the digital communication medium.

2. The method of claim 1, wherein the conflicting domain is one of:
an impersonating domain;
a typosquatting domain; or
an error domain.

3. The method of claim 2, further comprising:
identifying a plurality of conflicting domains to compare with the internet domain;
for each conflicting domain of the plurality of conflicting domains:
receiving, via the digital communication medium, one or more conflicting screenshots of a conflicting website of the conflicting domain; and
for each conflicting screenshot of the one or more conflicting screenshots, generating a conflicting perceptual hash from the conflicting screenshot; and
for each conflicting perceptual hash generated, calculating a second similarity between the first perceptual hash and the conflicting perceptual hash, wherein classifying the internet domain as the conflicting internet domain is also based on the calculated second similarities.

4. The method of claim 3, wherein:
identifying a plurality of conflicting domains includes identifying:
a plurality of impersonating domains;
a plurality of typosquatting domains; and
a plurality of error domains; and
the method further comprises:
for the plurality of impersonating domains, identifying a maximum impersonating similarity from the calculated second similarities;
for the plurality of typosquatting domains, identifying a maximum typosquatting similarity from the calculated second similarities;
for the plurality of error domains, identifying a maximum error similarity from the calculated second similarities; and
identifying a maximum similarity from the maximum impersonating similarity, the maximum typosquatting similarity, the maximum error similarity, and the first similarity, wherein classifying the internet domain as the conflicting internet domain is based on the maximum similarity.

5. The method of claim 4, wherein classifying the internet domain as the conflicting internet domain includes classifying the internet domain as one of:
an impersonating domain based on the maximum similarity being the maximum impersonating similarity;
a typosquatting domain based on the maximum similarity being the maximum typosquatting similarity; or
an error domain based on the maximum similarity being the maximum error similarity.

6. The method of claim 5, further comprising comparing the maximum similarity to a similarity threshold, wherein classifying the internet domain as the conflicting internet domain includes identifying the internet domain as the error domain in response to the maximum similarity being less than the similarity threshold.

7. The method of claim 1, wherein the second screenshot is of a login page of the seed website.

8. The method of claim 1, further comprising receiving, via the digital communication medium, passive domain name system (DNS) data of the internet domain, wherein classifying the internet domain as the conflicting internet domain is also based on the passive DNS data.

9. The method of claim 8, wherein the passive DNS data includes an internet protocol (IP) count indicating number of domains resolving to one of a same host or a same IP address to which the internet domain resolves.

10. The method of claim 9, further comprising calculating a change in IP count for the internet domain, wherein classifying the internet domain as the conflicting internet domain includes classifying the internet domain as an impersonating domain based on the change in IP count.

11. A system for classifying an internet domain and notifying of a conflicting internet domain, the system comprising:
one or more processors; and
a memory storing instructions that, when executed by the one or more processors, causes the system to perform operations comprising:
identifying an internet domain to be analyzed for conflicting with a seed domain;
receiving, via a digital communication medium, a first screenshot of an internet website of the internet domain;
generating a first perceptual hash from the first screenshot;
receiving a second screenshot of a seed website of the seed domain;
generating a second perceptual hash from the second screenshot;
calculating a first similarity between the first perceptual hash and the second perceptual hash;
classifying the internet domain as a conflicting internet domain based on the calculated first similarity;
generating a notification based on the internet domain being classified as the conflicting internet domain; and
transmitting the notification via the digital communication medium.

12. The system of claim 11, wherein the conflicting domain is one of:
an impersonating domain;
a typosquatting domain; or
an error domain.

13. The system of claim 12, wherein the operations further comprise:
identifying a plurality of conflicting domains to compare with the internet domain;
for each conflicting domain of the plurality of conflicting domains:
receiving, via the digital communication medium, one or more conflicting screenshots of a conflicting website of the conflicting domain; and
for each conflicting screenshot of the one or more conflicting screenshots, generating a conflicting perceptual hash from the conflicting screenshot; and
for each conflicting perceptual hash generated, calculating a second similarity between the first perceptual hash and the conflicting perceptual hash, wherein classifying the internet domain as the conflicting internet domain is also based on the calculated second similarities.

14. The system of claim 13, wherein:
identifying a plurality of conflicting domains includes identifying:
a plurality of impersonating domains;
a plurality of typosquatting domains; and
a plurality of error domains; and
the operations further comprise:
for the plurality of impersonating domains, identifying a maximum impersonating similarity from the calculated second similarities;
for the plurality of typosquatting domains, identifying a maximum typosquatting similarity from the calculated second similarities;
for the plurality of error domains, identifying a maximum error similarity from the calculated second similarities; and
identifying a maximum similarity from the maximum impersonating similarity, the maximum typosquatting similarity, the maximum error similarity, and the first similarity, wherein classifying the internet domain as the conflicting internet domain is based on the maximum similarity.

15. The system of claim 14, wherein classifying the internet domain as the conflicting internet domain includes classifying the internet domain as one of:
an impersonating domain based on the maximum similarity being the maximum impersonating similarity;
a typosquatting domain based on the maximum similarity being the maximum typosquatting similarity; or
an error domain based on the maximum similarity being the maximum error similarity.

16. The system of claim 15, wherein the operations further comprise comparing the maximum similarity to a similarity threshold, wherein classifying the internet domain as the conflicting internet domain includes identifying the internet domain as the error domain in response to the maximum similarity being less than the similarity threshold.

17. The system of claim 11, wherein the second screenshot is of a login page of the seed website.

18. The system of claim 11, wherein the operations further comprise receiving, via the digital communication medium, passive domain name system (DNS) data of the internet domain, wherein classifying the internet domain as the conflicting internet domain is also based on the passive DNS data.

19. The system of claim 18, wherein the passive DNS data includes an internet protocol (IP) count indicating number of domains resolving to one of a same host or a same IP address to which the internet domain resolves.

20. The system of claim 19, wherein the operations further comprise calculating a change in IP count for the internet domain, wherein classifying the internet domain as the conflicting internet domain includes classifying the internet domain as an impersonating domain based on the change in IP count.
